(19) United States
(12) Patent Application Publication
(10) Pub. No.: US 2025/0389634 A1
(43) Pub. Date: Dec. 25, 2025

(54) SAMPLE-TESTING CARTRIDGE WITH VARIED CHANNEL DIMENSIONS FOR HBA1C MEASUREMENTS

(71) Applicant: ORANGE BIOMED CO., LTD., Seoul (KR)

(72) Inventor: Ung-Hyeon Ko, Seoul (KR)

(21) Appl. No.: 19/244,087

(22) Filed: Jun. 20, 2025

Related U.S. Application Data
(60) Provisional application No. 63/662,965, filed on Jun. 21, 2024.

(51) Int. Cl. G01N 15/12; B01L 3/00; G01N 15/01

(52) U.S. Cl. CPC G01N 15/131; B01L 3/502761; G01N 15/01; B01L 2200/04; B01L 2300/0645; B01L 2300/0848; B01L 2300/0883; B01L 2400/0406

(57) ABSTRACT

Systems, devices, and methods for determining health characteristics are disclosed herein. In some embodiments, a method includes receiving a fluid sample from a user and transferring at least some of the biological cells of the fluid sample through a microchannel including (i) an upstream viscosity-elimination section sized to compress the biological cells and (ii) a downstream measurement section sized to keep the biological cells compressed to measure one or more elastic characteristics of the biological cells. The method can continue by measuring parameters of the biological cells at first and second detection regions of the downstream measurement section, and determining, based on the measured parameters of the biological cells at at least one of the first or second detection region, a health characteristic of the user.

### CROSS-REFERENCE TO RELATED APPLICATION

The present application claims the benefit of U.S. Provisional Patent Application No. 63/662,965, filed Jun. 21, 2024, the disclosure of which is incorporated herein by reference in its entirety.

### TECHNICAL FIELD

The present technology relates generally to analyte detection and sample-testing systems, and more particularly to sample-testing cartridges with varied channel dimensions for HbA1c measurements.

### BACKGROUND

A blood sugar test, which is generally performed to diagnose diabetes, measures the level of glucose in the blood and yields a blood sugar level. However, the blood sugar level is a temporary value and may change before or after meals, or according to other factors.

By contrast, a glycated hemoglobin test measures the level of glucose linked or combined within the hemoglobin residing in red blood cells. While the red blood cells are in blood, they are able to bind with glucose within the blood. By measuring or estimating an average amount of glucose that has been attached to hemoglobin over time, the glycated hemoglobin test can measure the glucose level accumulated over the average lifespan of a red blood cell (e.g., three months). Therefore, the glycated hemoglobin test is less affected by physical activities or food intake than other blood sugar tests. That is, the glycated hemoglobin level is more stable than the blood sugar level and may be a better reference for diagnosing diabetes.

Unfortunately, conventional glycated hemoglobin level measuring devices require complex technology and equipment that have limited accessibilities (e.g., only accessible to hospitals and laboratory levels of institutions). While continuous management of glycated hemoglobin level is required to manage diabetes and its prognosis, patients have very few options for tracking such management. Moreover, efforts to develop such accessible management methods are only recently being developed. Like blood sugar measurement devices that have been popularized for home use, efforts are being made to enable measurement of glycated hemoglobin level at home without visiting a clinic (see, e.g., Korean Patent Registration Publication KR2281500 (registration date: Jul. 20, 2021)). However, such efforts focus on biochemical methods that have several disadvantages, including lifespan limitations for required components, difficult storage methods, and low or unreliable measurement accuracy attributable to poor storage conditions or the skills of the user.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments shown, but are provided for explanation and understanding.

FIG. 1 is a block diagram illustrating an environment in which some embodiments of analyte level measuring systems can operate.

FIGS. 2A and 2B are isometric and enlarged top views, respectively, of a sample-testing system in accordance with some embodiments of the present technology.

FIG. 3 is a partially transparent isometric view of a sample-testing cartridge in accordance with some embodiments of the present technology.

FIG. 4 is an enlarged plan view of a portion of the sample-testing cartridge of FIG. 3.

FIG. 5 is an enlarged plan view of a detection region included in the sample-testing cartridge of FIG. 3.

FIG. 6 is a cross-sectional view of a microchannel at a first detection region included in the sample-testing cartridge of FIG. 3.

FIG. 7 is a cross-sectional view of the microchannel at a second detection region included in the sample-testing cartridge of FIG. 3.

FIG. 8 is a graph illustrating friction applied on a red blood cell traveling through the microchannel in accordance with some embodiments of the present technology.

FIG. 9 is an enlarged plan view of a capillary action inducement region of the sample-testing cartridge of FIG. 3.

FIGS. 10A-10D are plan views of the sample-testing cartridge of FIG. 3 illustrating a fluid sample traveling through the microchannel over time in accordance with some embodiments of the present technology.

FIG. 11 is a schematic view of various positions of a red blood cell traveling through the microchannel over time in accordance with some embodiments of the present technology.

FIGS. 12A-12E are graphs illustrating signal readings corresponding to the various positions of the red blood cell illustrated in FIG. 11.

FIG. 13 is a graph illustrating velocity fluctuations of red blood cells traveling through the microchannel in accordance with some embodiments of the present technology.

FIGS. 14A-14C illustrate a red blood cell of a patient with a relatively high HbAlc level traveling through the microchannel.

FIGS. 15A-15C illustrate a red blood cell of a patient with a relatively low HbAlc level traveling through the microchannel.

FIG. 16 is a graph illustrating normalized velocities of red blood cells traveling through the microchannel from patients with different HbA1c levels.

FIG. 17 is a graph illustrating correlation between HbA1c levels and elongation sizes of red blood cells traveling through the microchannel.

FIG. 18 is a graph illustrating distribution of elongation sizes of red blood cells from patients with different HbA1c levels.

FIG. 19 is a graph illustrating correlation between HbA1c levels, normalized velocities, and elongation sizes of red blood cells traveling through the microchannel.

FIGS. 20A and 20B are top and side views, respectively, of an average red blood cell.

FIG. 21 is a partially schematic plan view of an observation window of a different sample-testing cartridge configured in accordance with some embodiments of the present technology.

FIG. 22 is a cross-sectional view of the sample-testing cartridge of FIG. 21 at a first detection region configured in accordance with some embodiments of the present technology.

FIG. 23 is a cross-sectional view of the sample-testing cartridge of FIG. 21 at a second detection region configured in accordance with some embodiments of the present technology.

FIG. 24 is a flowchart illustrating a method for determining a health characteristic of a user in accordance with some embodiments of the present technology.

FIG. 25 is a flowchart illustrating a method for measuring a glycated hemoglobin level in accordance with some embodiments of the present technology.

FIG. 26 is a block diagram illustrating an example of a processing system in which at least some operations described herein can be implemented.

### DETAILED DESCRIPTION

### I. Overview

The following disclosure describes systems, devices, and methods for measuring analyte levels. More specifically, the present technology relates to a device that leverages microchannel manufacturing technology to measure an analyte level, such as glycated hemoglobin level or other similar analyte levels, at home. More specifically, one or more embodiments of the present technology include measuring a glycated hemoglobin level based on one or more physical characteristics of a sample (e.g., finger-blood samples or other sampling techniques). For example, the glycated hemoglobin level can be determined based on one or more physical characteristics (e.g., mechanical characteristics, deformability, stiffness/rigidity, elongation, etc.) of a glycated red blood cell. The system can include a cartridge with a microchannel having a channel configured to alter red blood cells to individually or collectively measure viscous properties of the cell(s) only, elastic properties of the cell(s) only, or both. In some embodiments, the microchannel is configured to cause deformation of the red blood cells for a sufficient length of time to reduce or eliminate time-dependent properties (e.g., viscosity-related properties of the cells) that affect measurement of non-time dependent properties (e.g., elastic properties of the cells). For example, the microchannel can have a time-dependency elimination region configured to hold the red blood cells in a compressed state for a sufficient length of time so as to reduce or eliminate time-dependency force effects. After reducing or eliminating the time-dependency effects, one or more of the non-time dependent properties of the cells are measured. The rate of deformation, amount of deformation, and/or time period of deformation can be measured and selected based on the properties to be analyzed and determined.

The system can utilize static structures within the cartridge (e.g., an end portion utilizing capillary effects to draw or pull the liquid) to route the glycated red blood cell through/across the microchannel. Based on the movement of the sample, the system can perform one or more routines (e.g., calibration routines, normalization routines) to, for example, operate the sensor, increase analyte detection accuracy, process collected data, or the like.

In some embodiments, a glycated hemoglobin level measuring system includes a sample-testing cartridge having the microchannel that compresses cells. The microchannel can have varied cross-sectional dimensions along the length of the microchannel. For example, the microchannel can be wider at locations near the inlet than locations near the outlet of the microchannel, or vice versa. The system can leverage the varied cross-sectional dimensions to obtain different data, which can be further processed to compute/estimate the analyte level. For example, the system can use the data obtained at one location along the microchannel to normalize the data obtained from another location.

For illustrative purposes, the present technology is described with respect to measuring one or more aspects related to glycation of red blood cells. However, it is understood that the present technology can be used to measure or analyze other fluid-suspended particulates, biological cells (e.g., white blood cells), and/or the like, and/or other characteristics or parameters (e.g., travel parameters such as instantaneous speed, average speed, acceleration, or combinations thereof). For example, embodiments of the present technology can be used to measure or calculate the viscosity, elasticity, viscoelasticity, cytoskeletal stiffness (e.g., cytoskeletal parameter, cytoskeletal characteristic, etc.), the rigidity, the deformability, size, and/or more, and/or can use such measured or calculated values to estimate a user's glycated hemoglobin levels (e.g., HbA1c levels), diagnose diseases (e.g., sickle cell disease), and/or the like.

In particular, as discussed in greater detail herein, embodiments of the present technology can leverage the fact that cells having different cytoskeletal stiffnesses lead to variations in their interactions with microchannels, surfaces, etc. due to, for example, friction forces within the microchannel. These variations in interactions lead to variations in travel or transit parameters (e.g., transit speed between electrodes, variations in speed along a zone, etc.), which can be correlated back to the cytoskeletal stiffnesses of the cells to determine one or more health characteristics of the user. For example, red blood cells associated with different HbA1c levels can have different cytoskeletal stiffnesses, so by measuring cytoskeletal stiffness indirectly by measuring speed, signal amplitude, and/or the like, embodiments of the present technology can accurately estimate the user's HbA1c level.

In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

Spatially relative terms (e.g., “beneath,” “below,” “over,” “under,” “above,” “upper,” “top,” “bottom,” “left,” “right,” “center,” “middle,” and the like) may be used herein for ease of description to describe one element's or feature's relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

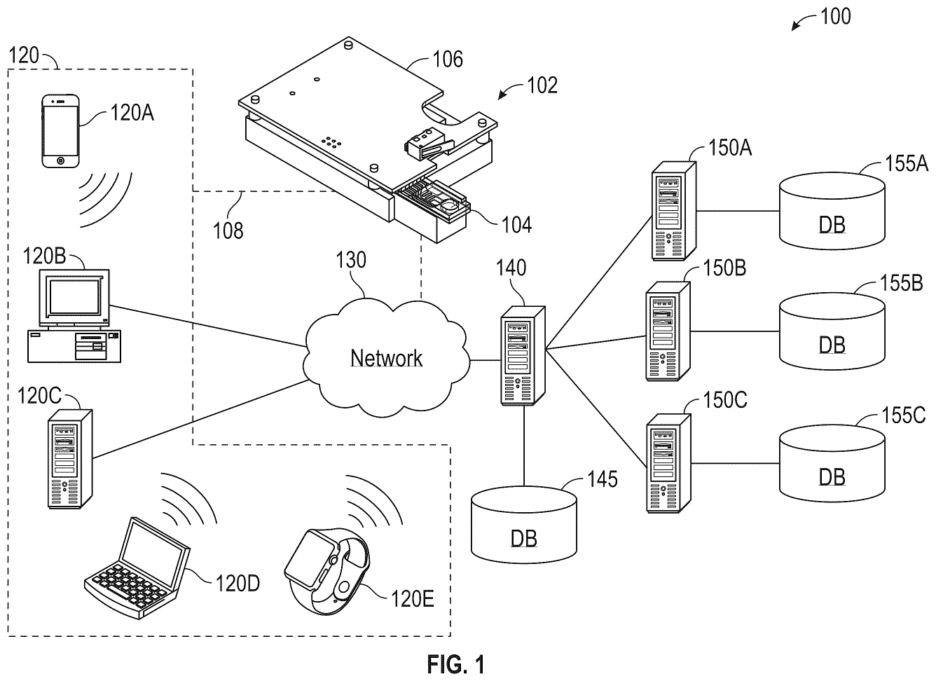

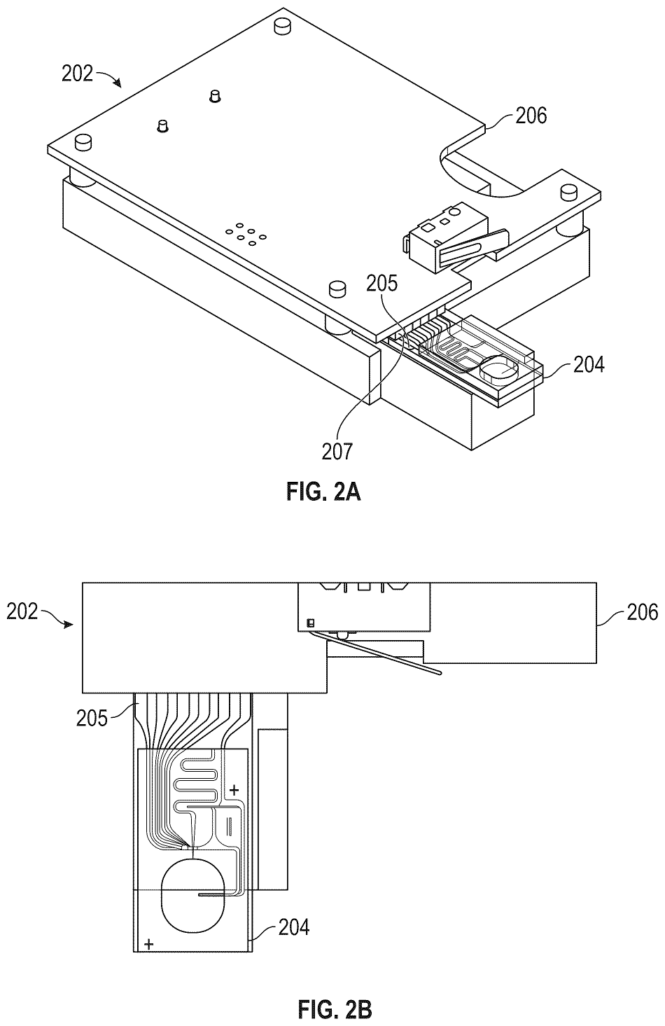

Reference numbers used in the figures of the present disclosure follow a numbering convention in which (i) the first digit or digits correspond to the first figure in which a particular clement or component is introduced and (ii) the remaining digits identify that particular element or component in the figures. Unless otherwise specified or made clear from context, similar references numbers are used across multiple figures to denote generally similar and/or identical components. For example, reference number 102 can be used to reference an element “2” that was first introduced in FIG. 1. Use of reference number 102 in FIG. 2 can identify the element “2” from FIG. 1 in FIG. 2. Use of reference number 202 in FIG. 2 can be used to reference an element “2” that was first introduced in FIG. 2, and that may (depending on context) be generally similar and/or identical to the element “2” corresponding to reference number 102 that was first introduced in FIG. 1.

### II. Operating Environment

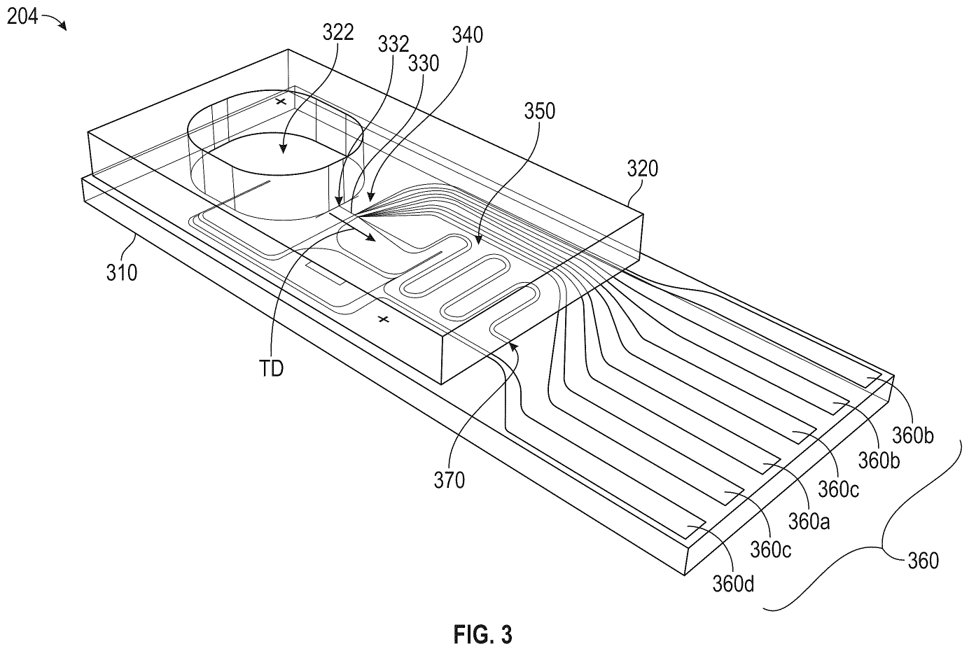

FIG. 1 is a block diagram illustrating an environment 100 in which some embodiments of an analyte level measuring system 102 can operate. The analyte level measuring system 102 can be include a sample-testing device or cartridge 104 (“the cartridge 104”) and a sensor or analysis apparatus 106 couplable to the cartridge 104. In some embodiments, the cartridge 104 includes an inlet configured to receive a blood sample (e.g., a diluted blood sample) and an outlet configured to release the blood sample. The inlet may be larger in width and/or depth than the outlet for easier entry of the blood sample. The analyte level measuring system 102 can perform one or more calibration and/or normalization routines (e.g., sensor calibration routines, electrode calibration routines, data normalization routines, viscoelasticity routines, elimination routines, etc.), signal processing parameters (e.g., calibration parameters), and other routines to adjust performance. Example features of the cartridge 104 are discussed in connection with FIGS. 3-10D.

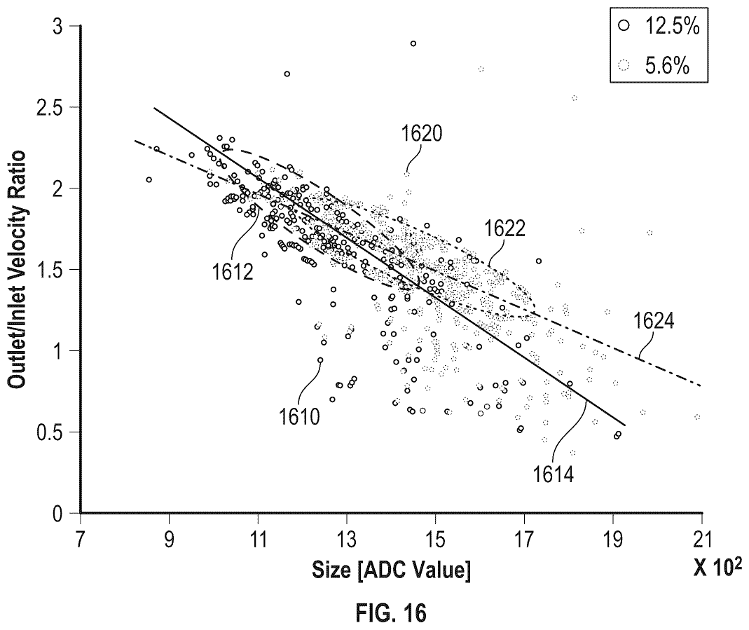

The analysis apparatus 106 can communicate, via a direct wired or wireless communication link 108 and/or a network 130, with one or more client computing devices 120, examples of which include a smart phone or tablet 120A, a desktop computer 120B, a computer system 120C, a laptop computer 120D, and a wearable device 120E. These are only examples of some of the devices, and other embodiments can include other computing devices, such as other types of personal and/or mobile computing devices. Client computing devices 120 can collect various data from a user (e.g., analyte data from a wearable analyte monitor (for example, a continuous glucose monitor (CGM)), sleep data, heart rate data, blood pressure data, dietary information, exercise data, health metrics, etc.) and communicate the collected data to the analysis apparatus 106 and/or a service provider (e.g., a remote device/system, such as a server). The collected data can be leveraged for the testing/measuring processes. For example, the analysis apparatus 106 can include a processing system programmed to provide output based on correlates between real-time CGM data and glycated Alc hemoglobin levels. For example, the processing system can include a controller with one or more processors, memory storing programs for calibration and/or analyzing the collected data executable to, for example, identify individual cells, overlapping of cells, speed of travel of cells, flow rate of samples, etc. Example calibration routines are discussed in connection with FIG. 16. The analysis apparatus 106 can perform one or more sensor calibration routines, adjusting signal processing parameters (e.g., thresholding values, filtering parameters, calibration parameters, etc.), testing settings, routines, and/or algorithms based on the collected data. The analysis apparatus 106 can transmit data (e.g., raw data, processed data, sensor signals, etc.) to a remote device and receive data (e.g., calibration parameters, signal processing parameters, algorithms, firmware updates) from a remote device. The analysis apparatus 106 can perform one or more viscoelasticity routines to measure viscoelasticity properties, viscosity, elasticity, or the like. The analysis apparatus 106 can perform one or more elimination routines to eliminate time-dependent effects (e.g., viscosity-related behavior) to measure time independent properties (e.g., modulus of elasticity of cells, cytoskeletal stiffness, rigidity, etc.).

The client computing devices 120 can also communicate information, such as test results or other notifications, from the analysis apparatus 106 and/or the service provider to the user. Accordingly, the computing devices 120 can operate in a networked environment using logical connections through the network 130 to the analysis apparatus 106 and/or one or more remote computers, such as a server computing device or a cloud computing environment. The networked environment can also be used to provide software updates to algorithms used in the analysis apparatus 106 and/or the one or more client computing devices 120.

In some embodiments, the analysis can be performed or shared with a backend system (e.g., one or more computing devices, such as servers, and/or data bases configured to perform the analysis of the collected data). For example, the computing environment can include one or more computing devices (e.g., servers 140 and/or 150A-C, databases 155A-C, or the like) communicatively coupled to the client computing devices 120 and/or the analysis apparatus 106. For the illustrated example, the server 140 can be an edge server which receives client requests and coordinates fulfillment of those requests through other servers, such as servers 150A-C. Server computing devices 140 and 150A-C can include computing systems. Though each server computing device 140 and 150A-C is displayed logically as a single server, server computing devices can each be a distributed computing environment encompassing multiple computing devices located at the same or at geographically disparate physical locations. In some implementations, each server 150A-C corresponds to a group of servers.

Client computing devices 120 and server computing devices 140 and 150A-C can each act as a server or client to other server/client devices. Server 140 can connect to a database 145. For example, the servers 150A-C can each connect to a corresponding database 155 A-C. As discussed above, each server 150A-C can correspond to a group of servers, and each of these servers can share a database or can have their own database. Databases 145 and 155A-C can warehouse (e.g., store) information. Though databases 145 and 155A-C are displayed logically as single units, databases 145 and 155A-C can each be a distributed computing environment encompassing multiple computing devices, can be located within their corresponding server, or can be located at the same or at geographically disparate physical locations.

Network 130 can be a local area network (LAN), a wide area network (WAN), and/or other wired, wireless, or combinational networks. Portions of network 130 may be the Internet or some other public or private network. Client computing devices 120 can be connected to network 130 through a network interface, such as by wired or wireless communication. While the connections between server 140 and servers 150A-C are shown as separate connections, these connections can be any kind of local, wide area, wired, or wireless network, including network 130 or a separate public or private network.

In some embodiments, the analysis apparatus 106 can initiate one or more tests for the blood sample collected at the cartridge 104. The analysis apparatus 106 can interact with the cartridge 104 to collect and analyze one or more measurements regarding the blood sample. The analysis apparatus 106 can communicate the analysis results to the server 140 corresponding to other entities, such as a healthcare provider, a further health tracking or comprehensive health analysis service, or the like. Alternatively, the analysis apparatus 106 can provide the measurements to the server 140 (e.g., without local analysis at the analysis apparatus 106, and the remote service provider can analyze the provided measurements.

FIGS. 2A and 2B are isometric and enlarged top views, respectively, of a sample-testing system 202 in accordance with some embodiments of the present technology. The sample-testing system 202 can be an example of the analyte level measuring system 102 of FIG. 1. The sample-testing system 202 can include a sample-testing apparatus or cartridge 204 (“the cartridge 204”) and an analysis apparatus 206. As shown, electrodes 205 of the cartridge 204 can be in contact with electrodes 207 of the analysis apparatus 206 such that the analysis apparatus 206 is operably and electrically coupled to the cartridge 204.

As discussed further herein, the cartridge 204 can receive a sample (e.g., a patient's blood sample), and particulates (e.g., red blood cells) in the sample can travel through a channel included in the cartridge 204. In some embodiments, the blood sample is diluted in a saline solution in a ratio between 1:50-1:200 to facilitate analysis of individual red blood cells.

The analysis apparatus 206 can send (e.g., via the electrodes 205, 207) an input signal to the channel and receive (e.g., via the electrodes 205, 207) an output signal affected by the particulates traveling through the channel of the cartridge 204. The output signal can be analyzed to determine one or more parameters (e.g., glycated hemoglobin level) of the particulates from the sample.

### III. Sample-Testing Cartridges

FIG. 3 is a partially transparent isometric view of the sample-testing cartridge 204 in accordance with some embodiments of the present technology. The cartridge 204 can include a plate-shaped chip or substrate 310 and a sensor body 320 disposed thereon. The substrate 310 and/or the sensor body 320 can be made from elastomers (e.g., polydimethylsiloxane (PDMS)), glass (c.g., borate glass, borosilicate glass, soda-lime glass), or other suitable materials (e.g., photoresist and/or Polyimide). The sensor body 320 can define an opening or cavity 322 into which a user can deposit a sample (e.g., blood sample). A microchannel or other microfluidic pattern 330 (“the microchannel 330”) extending from the cavity 322 can be formed on the substrate 310 and/or the sensor body 320. The microchannel 330 can be fluidically coupled to the cavity 322, and the microchannel 330 can be configured to control flow of the sample received in the cavity 322. In some embodiments, electrodes 360 (also referred to as a blood cell analyzer) are patterned onto the substrate 310 (e.g., onto a top surface of the substrate 310) by photolithography, chemical vapor deposition, and/or other techniques such that the electrodes 360 are positioned adjacent to the microchannel 330.

In some embodiments, prior to attachment to the substrate 310, the sensor body 320 (e.g., liquid PDMS) is applied onto a patterned wafer and cured (e.g., at 70-150° C. for 0.5-4 hours). The patterned wafer and the curing process can be used to create specific patterns (e.g., the microchannel 330, a microchannel entrance, a microchannel exit) on the sensor body 320 (e.g., onto a bottom surface of the sensor body 320) using a biopsy punch and/or other tools. In some embodiments, the microchannel 330 is formed by lithography (e.g., soft lithography, photolithography). The patterned sensor body 320 can then be attached to the substrate 310 such that, for example, the microchannel 330 on the sensor body 320 aligns properly with the electrodes 360 on the substrate 310.

In some embodiments, the substrate 310, which may include the electrodes 360, is further patterned to include the microchannel 330. For example, the substrate 310 can be made from glass and the microchannel 330 can be formed via polyimide patterning. The polyimide patterning or layer (also referred to herein as “the microchannel layer”) can be formed via spin coating, masking, and/or other suitable techniques for achieving desired dimensions of the microchannel 330. The sensor body 320 (e.g., without any patterning, and/or also made from glass) can then be disposed over and attached to the substrate 310. In some embodiments, a hot press is applied to bond the polyimide patterning to the sensor body 320. The hot press can last for at least 1 minute, 2 minutes, 3 minutes, 3 minutes, 5 minutes, 6 minutes, 7 minutes, 8 minutes, 9 minutes, 10 minutes, or between 1-10 minutes. The high temperature and the pressure from the hot press can induce ionic movement and, consequently, surface-level covalent bonding between the polyimide patterning and the sensor body 320.

Manufacturing the cartridge 204 in this manner can be advantageous because by patterning both the microchannel 330 and the electrodes 360 on the substrate 310, the microchannel 330 and the electrodes 360 can be pre-aligned on the substrate 310 when the substrate 310 and the sensor body 320 are attached. This can avoid the need to precisely align the substrate 310 and the sensor body 320, which can be difficult and time-consuming. Also, aside from the polyimide patterning, both the substrate 310 and the sensor body 320 can be made of glass, providing the cartridge 204 with high hydrophilicity and long-term stability (e.g., minimal changes in wettability over time, minimal material degradation). Accordingly, the cartridge 204 can be used to consistently produce predictable flow curves, eliminate or at least reduce the need for fluidic graph correction during data analysis, and/or the like.

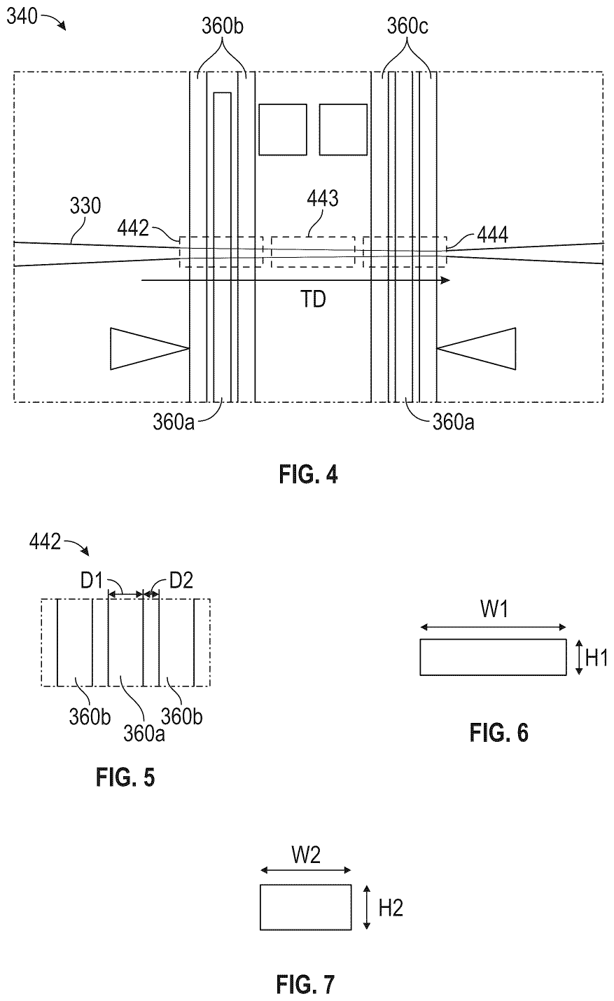

In the illustrated embodiment, the microchannel 330 extends from the cavity 322 to an edge of the sensor body 320. In particular, the microchannel 330 has an inlet 332 fluidly connected to the cavity 322, an outlet 370 fluidly connected to the environment and/or a collection pool (not shown), an observation window 340 extending from the inlet 332, and a capillary action inducement region 350 extending between the observation window 340 and the outlet 370. Red blood cells (or other particulates) in the sample received in the cavity 322 can travel along the microchannel 330 in travel direction TD, moving in through the inlet 332, though the observation window 340 and the capillary action inducement region 350, and to the outlet 370. The electrodes 360 can be coupled to the microchannel 330 at the observation window 340. Details of the microchannel 330 and the electrodes 360 are described in further detail below with respect to FIGS. 4-10D.

The electrodes 360 can include one or more reference or input electrodes 360a, one or more first region electrodes 360b, one or more second region electrodes 360c, and one or more sample detection electrodes 360d. As discussed further herein, the input electrodes 360a can receive input signals (e.g., from the analysis apparatus 206 in FIG. 2A) and transmit the input signals to one or more points in the observation window 340. The first region electrodes 360b and the second region electrodes 360c can be positioned to receive output signals affected by the particulates (e.g., red blood cells) traveling through first and second regions, respectively, in the observation window 340. The first region electrodes 360b and the second region electrodes 360c can transmit the output signals to the analysis apparatus 206 and/or other computing device. The sample detection electrode 360d can extend into the cavity 322, as shown, to detect when a sample (e.g., a blood sample) is dropped or deposited into the cavity 322. In some embodiments, a user interface of the analysis apparatus 206 (or other device) can, in response to the sample detection electrode 360d detecting the sample drop, switch to an analysis screen.

In some embodiments, the cartridge 204 is reusable or disposable. As used herein, the term “disposable” when applied to a system or component (or combination of components), such as a cartridge or sensor, is a broad term and means, without limitation, that the component in question is used a finite number of times and then discarded. Some disposable single-use components are used only once and then inoperable. Other disposable components are used more than once and then discarded. For example, a disposable single-sample cartridge can be used to analyze a single sample and then discarded. The system or cartridge prevents multi-sample usage by destroying or preventing operation of components after analysis of the single sample. In other embodiments, the system can be programmed to identify a disposable cartridge and then authorizes usage of the cartridge for limited uses (e.g., a number of samples that can be analyzed).

FIG. 4 is an enlarged plan view of the observation window 340 of the microchannel 330. As shown, the observation window 340 includes a first detection region 442, a second detection region 444, and a transition region 443 extending therebetween. The first detection region 442 is located closer to the inlet 332 of the microchannel 330 (e.g., closer to the cavity 322), and the second detection region 444 is located closer to the outlet 370 of the microchannel 330 (e.g., closer to the capillary action inducement region 350). Particulates can travel through the microchannel 330 in the travel direction (TD) such that the particulates first travel through the first detection region 442, then through the transition region 443, then through the second detection region 444.

As shown, a first portion of the input electrode 360a extends generally perpendicular to the microchannel 330 through the first detection region 442. Two first region electrodes 360b extend generally perpendicular to the microchannel 330 through the first detection region 442 on either side of the first portion of the input electrode 360a. A second portion of the input electrode 360a extends generally perpendicular to the microchannel 330 through the second detection region 444. Two second region electrodes 360c extend generally perpendicular to the microchannel 330 through the second detection region 444 on either side of the second portion of the input electrode 360a. The portions of the electrodes 360 intersecting the microchannel 330 can be exposed to the inside of the microchannel 330. For example, contents (e.g., liquid and/or particulates, such as red blood cells) within the microchannel 330 can directly contact the exposed portions of the electrodes 360. Accordingly, as the particulates traverse through the microchannel 330 along the TD, the particulates can sequentially contact/overlap the electrodes 360.

FIG. 5 is an enlarged plan view of the first detection region 442. Each of the portions of the electrodes 360 intersecting the microchannel 330 can have a dimension D1 (e.g., width). Dimension D1 can be between 10-30 μm, such as 15 μm, 20 μm, 25 μm, etc. Also, each of the portions of the electrodes 360 intersecting the microchannel 330 can have a thickness (dimension into the page) between 50-250 nm, such as 100 nm, 150 nm, 200 nm, etc. The three portions of the electrodes 360 intersecting the microchannel 330 can be spaced apart by dimension D2 (e.g., gap). Dimension D2 can be between 1-20 μm, such as 5 μm, 10 μm, 15 μm, etc. In other embodiments, the electrodes 360b can have a different dimension/width than electrode 360a, and/or the separation distances between (1) a first of the electrodes 360b and the electrode 360a and (2) the electrode 360a and the second of the electrodes 360b can be different. Moreover, in some embodiments, one or more of the dimensions of the electrodes 360 in the second detection region 444 can match that/those of the electrodes 360 in the first detection region 442.

FIG. 6 is a cross-sectional view of the microchannel 330 at the first detection region 442. The microchannel 330 at the first detection region 442 can have a generally rectangular cross-section with a first width W1 and a first height H1. The dimensions of the microchannel 330 at the first detection region 442 can be greater than the dimensions of the expected/targeted particulates but smaller enough to allow one particulate to pass (e.g., small enough to prevent multiple particulates to overlap and pass over a single location). For the example of targeting measurements of human red blood cells, the first width W1 can be between 8-20 μm, such as 10 μm, 14 μm, 18 μm, etc. The first height H1 can be between 1-5 μm, such as 2 μm, 3 μm, 4 μm, etc.

FIG. 7 is a cross-sectional view of the microchannel at the second detection region 444. The microchannel 330 at the second detection region 444 can have a generally rectangular cross-section with a second width W2 and a second height H2. The dimensions of the microchannel 330 at the second detection region 444 can be lesser than the dimensions of the expected/targeted particulates, such as to squeeze/compress the particulates passing through the second detection region 444. For the example of targeting measurements of human red blood cells, the second width W2 can be between 2-8 μm, such as 4 μm, 5 μm, 6 μm, etc. The second height H2 can be between 1-5 μm, such as 2 μm, 3 μm, 4 μm, etc. In particular, the cross-section at the second detection region 444 can be smaller than the cross-section at the first detection region 442 such that the transition region 443 (FIG. 4) comprises a narrowing region. The transition region 443 can have a gradually narrowing cross-section (as illustrated in FIG. 4), can be arranged in a serpentine pattern, can have a sudden contraction pipe geometry with or without gradually narrowing cross-sections on either side of the sudden contraction, etc. The microchannel 330 can have a rectangular, circular, or other cross-sectional shapes (e.g., elliptical) and/or dimensions.

The microchannel 330 can be sized to allow or promote a single particulate (e.g., a single red blood cell) to pass through a cross-section of the microchannel 330 at any given moment in time. In some embodiments, the microchannel 330 is sized to avoid compressing or minimally compress the particulate passing through the first detection region 442, and sized to compress the particulate passing through the second detection region 444. For example, a red blood cell can have, on average, a width or diameter of about 7-8 μm and a height or thickness of about 2.5 μm. In one example, the microchannel 330 has a first width W1 of about 13 μm and a first height H1 of about 2.8 μm. Therefore, red blood cells can mostly travel through the first detection region 442 without being compressed by the microchannel 330. In the same example, the microchannel has a second width W2 of about 4.5 μm and a second height H2 of about 2.8 μm. Therefore, red blood cells can mostly travel through the second detection region 444 while being compressed by the microchannel 330. In some embodiments, the microchannel 330 has a constant cross-section within the first detection region 442 and/or within the second detection region 444, as illustrated in FIG. 4. In other embodiments, the microchannel 330 has a varying cross-section within the first detection region 442 and/or within the second detection region 444.

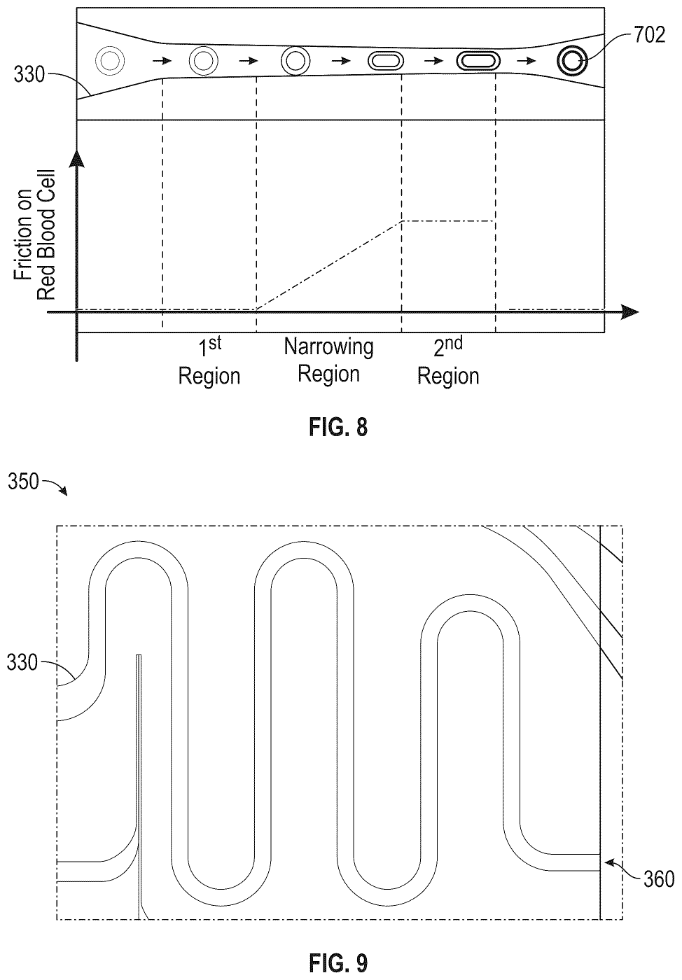

FIG. 8 is a graph illustrating friction applied on a red blood cell 702 traveling through the microchannel 330 (e.g., applied by the walls of the microchannel 330) in accordance with some embodiments of the present technology. As discussed above with reference to FIGS. 4, 6, and 7, the microchannel 330 has a first region (e.g., the first detection region 442) having a relatively larger cross-section, a narrowing region (e.g., the transition region 443) in which the cross-section narrows, and a second region (e.g., the second detection region 444) having a relatively smaller cross-section. Therefore, as the red blood cell 702 travels through the microchannel 330, the red blood cell 702 initially experiences (i) no, negligible, or relatively low friction while traveling through the first region, (ii) increasing amount of friction while traveling through the narrowing region, and (iii) relatively high (e.g., higher than the amounts within the first and narrowing regions) friction while traveling through the second region. In the graph of FIG. 8, the friction applied on the red blood cell 702 in each of the first and second regions is generally constant, indicating a constant cross-section within the respective region. Also, in the graph of FIG. 8, the friction applied on the red blood cell 702 in the narrowing region increases generally lincarly. In other embodiments, the friction applied can increase in other patterns depending on the specific geometry of the transition region 443.

FIG. 9 is an enlarged plan view of the capillary action inducement region 350. In some embodiments, the capillary action inducement region 350 initiates and/or induces flow of the sample through the microchannel 330 via capillary action. As shown, the microchannel 330 extends from the observation window 340 towards the outlet 370 in a generally serpentine pattern. The serpentine pattern allows the microchannel 330 to extend along a longer length than if the microchannel 330 extended linearly between the observation window 340 and the outlet 370. The longer length can improve inducement of capillary action. The shape, length, and/or cross-sectional shape and/or dimensions of the microchannel 330 can be selected based at least in part on, for example, the type of sample to be received in the cartridge 204, the analyte level to be determined, the algorithm used, the electrode configuration, etc. Moreover, the materials of the inner surface of the microchannel 330 can be selected for their hydrophilicity to initiate and control flow velocity through the microchannel 330. The surface finish and composition of the surface can be selected based on the target contact angle, hydrophobic/hydrophilic surface characteristics, capillary action, frictional interaction, etc. In some embodiments, the user can add liquid (e.g., water, saline, etc.) to the sample (e.g., in the cavity 322) to further facilitate fluid flow through the microchannel 330.

Once the sample exits the microchannel 330 at the outlet 370, the sample can enter a collection pool and/or evaporate to allow the flow to continue. Therefore, the cartridge 204 can allow the sample to flow through the microchannel 330 without the use of any active components, such as a pump. Accordingly, the capillary action inducement region 350 can provide a generally consistent, steady-state flow of the particulate, such as without a rhythmic/periodic disruption or pulsing that may be caused by an external mechanical pump. In some embodiments, the capillary action inducement region 350 can maintain flow of the sample along/through the microchannel 330 for a detection period of time of at least 1 minute, 5 minutes, 10 minutes, 20 minutes, etc. In some embodiments, the capillary action inducement region 350 maintains a sample flow rate along/through the microchannel 330 at or above a threshold sample flow rate. The threshold sample flow rate can be sufficiently high to cause at least one red blood cell to traverse the observation window 340 per minute. In some embodiments, however, the microchannel 330 can be fluidically coupled to a pump configured to control pressure before, in, and/or after the microchannel 330, thereby facilitating the movement of the sample through the microchannel 330.

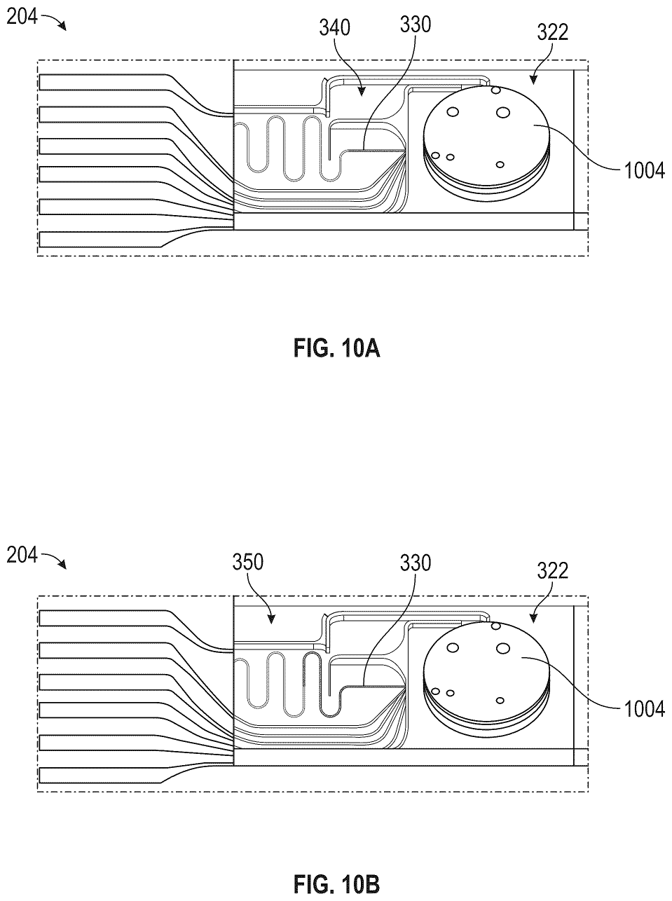

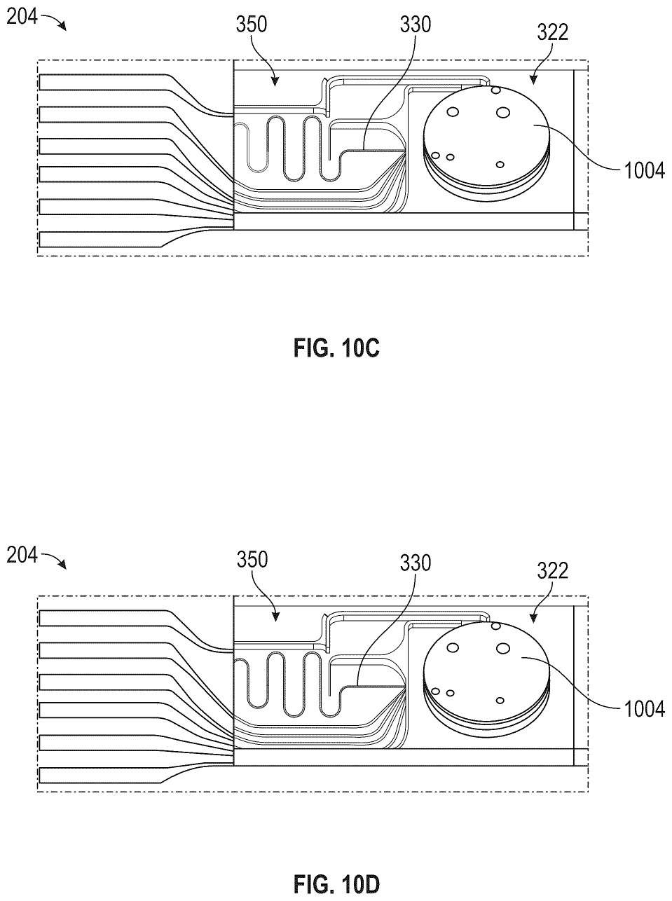

FIGS. 10A-10D are plan views of the cartridge 204 illustrating a fluid sample 1004 traveling through the microchannel 330 over time in accordance with some embodiments of the present technology. As shown in FIGS. 10A-10D, the fluid sample 1004 (e.g., blood sample, blood sample mixed with other liquids such as a saline solution (e.g., 0.9% sodium chloride), etc.) can be received in the cavity 322. As discussed above, capillary action can initiate flow of the fluid sample 1004 through the microchannel 330, which is in fluid communication with the cavity 322. The fluid sample 1004 can flow through the microchannel 330 past the observation window 340 and the capillary action inducement region 350, and exit the microchannel 330 to be collected in a collection pool and/or evaporate.

The microchannel 330 is configured (e.g., via sizing, material selection, shaping) to achieve a targeted flow rate of the fluid sample 1004. The FIGS. 10A-10D can illustrate a progress of the sample along/through the microchannel 330 according to the targeted flow rate. For example, measuring from a time since the fluid sample 1004 was received in the cavity 322, FIG. 10A can correspond to about 2 minutes or less, FIG. 10B can correspond to about 6 minutes or less, FIG. 10C can correspond to about 14 minutes or less, and FIG. 10D can correspond to about 20 minutes or less. In other examples, the microchannel 330 can be configured to achieve different flow rates such that FIGS. 10A-10D correspond to different times since the fluid sample 1004 was received in the cavity 322.

### IV. Example Measurements and Analysis

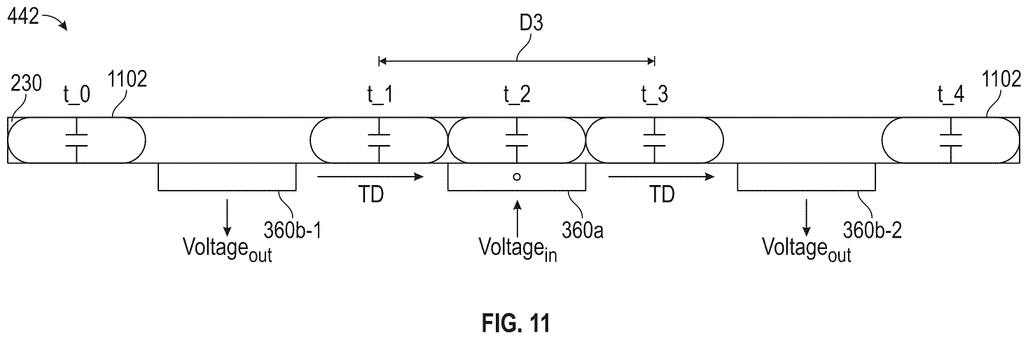

FIG. 11 is a schematic view of a red blood cell 1102 traveling through the microchannel 330 at five different positions/times around or within the first detection region 442 in accordance with some embodiments of the present technology. The first detection region 442 can be defined as the space in the microchannel 330 extending between a first one 360b-1 and a second one 360b-2 of the first region electrodes. As the red blood cell 1102 travels near and through the first detection region 442, an input or a reference signal pattern may be generated (e.g., by the analysis apparatus 206) in the voltages communicated via the input electrode 360a (indicated by Voltagein). In other words, as the particulate enters the space between the communicating electrodes 360, the particulate or the portion thereof in the space (e.g., the communicative channel for the voltage) can alter the electrical characteristic (e.g., the capacitance) of the space.

As an illustrative example, the system (at, e.g., the analysis apparatus 206) can provide a reference input signal Voltagein (e.g., an AC signal having amplitude of 400-1000 mV and a frequency of 10-60 kHz) through the input electrode 360a. The input signal can travel through the space in the microchannel 330 (e.g., the electrolyte and/or red blood cell 1102 therein depending on the position of the red blood cell 1102) and return through the first region electrodes 360b positioned on either side of the input electrode 360a (indicated by Voltageout). The system can generate/detect the reference signal pattern based on (1) measuring the Voltageout at the output electrodes 360b-1 and 360b-2 and (2) computing a difference between the Voltageout measured at the output electrodes 360b-1 and 360b-2. When the detection region does not include a red blood cell, the computed difference in the measured voltages can be static, such as for a DC voltage level or a base pattern. As the particulate enters and traverses across the detection region, the presence of the red blood cell can sequentially change the electrical characteristic of the channel (1) between electrodes 360b-1 and 360a and then (2) between 360a and 360b-2. Accordingly, the computed difference can have a sequence of one or more peaks and valleys (e.g., a positive peak followed by a negative valley) that deviate from the static state according to the changes in the electrical characteristic.

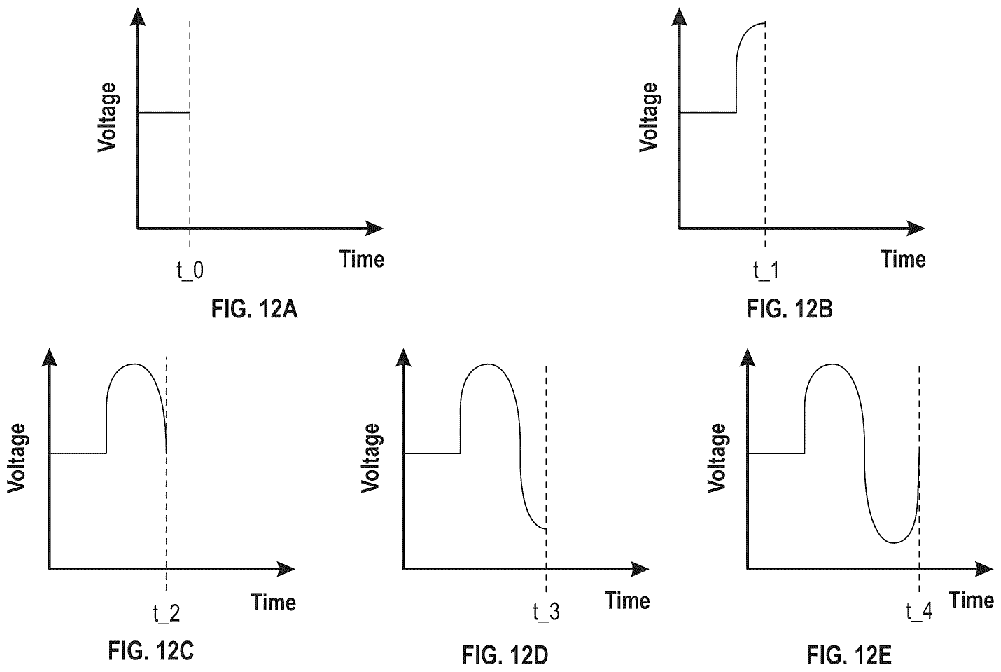

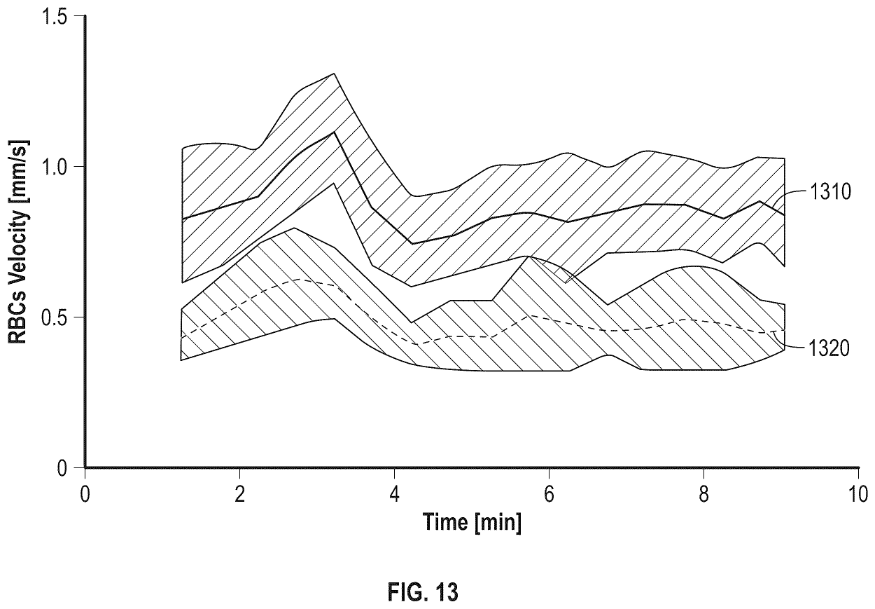

FIGS. 12A-12E are graphs illustrating the signal readings from the first region electrodes 360b corresponding to the various positions, respectively, of the red blood cell 1102 illustrated in FIG. 11. More specifically, the horizontal axis represents time and the vertical axis represents the voltage level for the difference between the signals received by the first one 360b-1 and the second one 360b-2 of the first region electrodes. The graphs thus illustrate phase shifted signals representing the phase changes of the output signal. Details of example sensor circuits and their measurement operations are further disclosed in U.S. Pat. No. 11,747,348, filed Dec. 9, 2022, and titled “APPARATUS FOR MEASURING GLYCATION OF RED BLOOD CELLS AND GLYCATED HEMOGLOBIN LEVEL USING PHYSICAL AND ELECTRICAL CHARACTERISTICS OF CELLS, AND RELATED METHODS,” and U.S. Pat. No. 11,852,577, filed Dec. 9, 2022, and titled “APPARATUS FOR MEASURING PROPERTIES OF PARTICLES IN A SOLUTION AND RELATED METHODS,” the disclosures of which are incorporated herein by their entireties. The graphs of FIGS. 12A-12E are simplified (e.g., omits noise) for illustrative purposes.

At time to, the red blood cell 1102 is at a first position proximal to, but not yet past, the first one of the first region electrodes 360b-1. Because the red blood cell 1102 is not positioned within the first detection region 442, the reference signal received at the first region electrodes 360b is not yet affected by the red blood cell 1102 and may be equal/synchronized between the first and second ones of the first region electrodes 360b-1, 360b-2. Therefore, as shown in FIG. 12A, the difference signal remains at a flat voltage level (e.g., 0V or a DC offset voltage) at time to.

At time t1, the red blood cell 1102 is at a second position between the first one of the first region electrodes 360b-1 and the input electrode 360a. Thus, the signal traveling from the input electrode 360a to the first one of the first region electrodes 360b-1 is affected by the red blood cell 1102, and the signals received by the first and second ones of the first region electrodes 360b-1, 360b-2 are different from each other. Accordingly, as shown in FIG. 12B, the difference signal is at a non-zero, e.g., a maximum voltage level at time t1.

At time t2, the red blood cell 1102 is at a third position at the input electrode 360a. Thus, the signal traveling from the input electrode 360a to the first and second ones of the first region electrodes 360b-1, 360b-2 may be affected by the red blood cell 1102, but are affected equally such that the signals received are similar or the same. Accordingly, as shown in FIG. 12C, the difference signal is at 0V or the DC offset voltage at time t2.

At time t3, the red blood cell 1102 is at a fourth position between the input electrode 360a and the second one of the first region electrodes 360b-2. Thus, the signal traveling from the input electrode 360a to the second one of the second region electrodes 360b-2 is affected by the red blood cell 1102, and the signals received by the first and second ones of the first region electrodes 360b-1, 360b-2 are different from each other. Accordingly, as shown in FIG. 12D, the difference signal is at a non-zero, minimum voltage level at time t3.

At time t4, the red blood cell 1102 is at a fifth position beyond the second one of the first region electrodes 360b-2. Because the red blood cell 1102 is not positioned within the first detection region 442, the reference signal received at the first region electrodes 360 is no longer affected by the red blood cell 1102 and is equal between the first and second ones of the first region electrodes 360b-1, 360b-2. Therefore, as shown in FIG. 12E, the difference signal remains at the flat voltage level (e.g., 0V or a DC offset voltage) from time t₄.

As illustrated in the graphs of FIGS. 12A-12E, the resulting plot can be a sinusoidal wave with one period corresponding to the red blood cell 1102 traveling fully through the first region 442. Therefore, as discussed further herein, various parameters of the resulting plot (e.g., amplitude, period, symmetry, etc.) can be analyzed to determine various travel parameters of the red blood cell 1102 (e.g., velocity, acceleration, elongation, etc.). For example, the velocity of the red blood cell 1102 traveling through the first detection region 442 can be calculated as

$$velocity = \frac{D 3}{{t}_{3} - {t}_{1}} ,$$

where (a) D3 is the distance between (i) the midpoint between the first one of the first region electrodes 360b-1 and the input electrode 360a and (ii) the midpoint between the second one of the first region electrodes 360b-2 and the input electrode 360a, and (b) t₃-t₁ is the time it takes for the red blood cell 1102 to travel the distance D3 (e.g., measured by taking the difference between t₃ and t₁, which correspond to the peak (FIG. 12B) and the trough (FIG. 12D), respectively, of the phase shift signal). The travel parameters can then be used to determine various characteristics of the red blood cell 1102 (e.g., cell size, deformability, glycation level, potential diseases, etc.). It is also appreciated that the signal measurement process for the first detection region 442 illustrated in FIGS. 11-12E can apply equally to a signal measurement process for the second detection region 444.

FIG. 13 is a graph illustrating velocity fluctuations of red blood cells traveling through the microchannel 330 over time in accordance with some embodiments of the present technology. More specifically, FIG. 13 illustrates how the velocities of red blood cells (e.g., as measured at one location along the microchannel 330) change as more red blood cells are introduced into and routed across the microchannel 330 throughout a measurement period. Plot 1310 illustrates the average velocity of the red blood cells measured at the second detection region 444 (closer to the outlet) and plot 1320 illustrates the average velocity of the red blood cells measured at the first detection region 442 (closer to the inlet). The shaded bands around the plots 1310, 1320 can present the range of velocities measured.

As shown, the velocities can exhibit an initial rise (e.g., at about 3 minutes) followed by an exponential decay. In other words, an initial set of blood cells may move faster at the beginning of a test, and subsequent samples may move slower as the test progresses. This may be attributable to, for example, the capillary action that initiates the sample flow, the amount of red blood cells in the opening and the collection pool, and the evaporation at the end of the microchannel 330. In some cases, measurements of different samples, measurements of different particulates (e.g., white blood cells), and/or measurements taken using different types of sensors can exhibit different velocity profiles over the measurement period, and can also be affected by varying environmental factors (e.g., temperature, humidity, pressure), experimental conditions (channel dimension error, manufacturing error, surface roughness), and other factors that may affect speed. One method may be to focus the analysis on a portion of the velocity/time graph, such as a portion in the declining or terminal section (e.g., a percentage delay or a predetermined offset after the peak velocity) to compute a more accurate reading for the user. Another method, as discussed further herein, can be to normalize the data to compensate for the variations (e.g., sample-to-sample and/or particulate-to-particulate variations) described above.

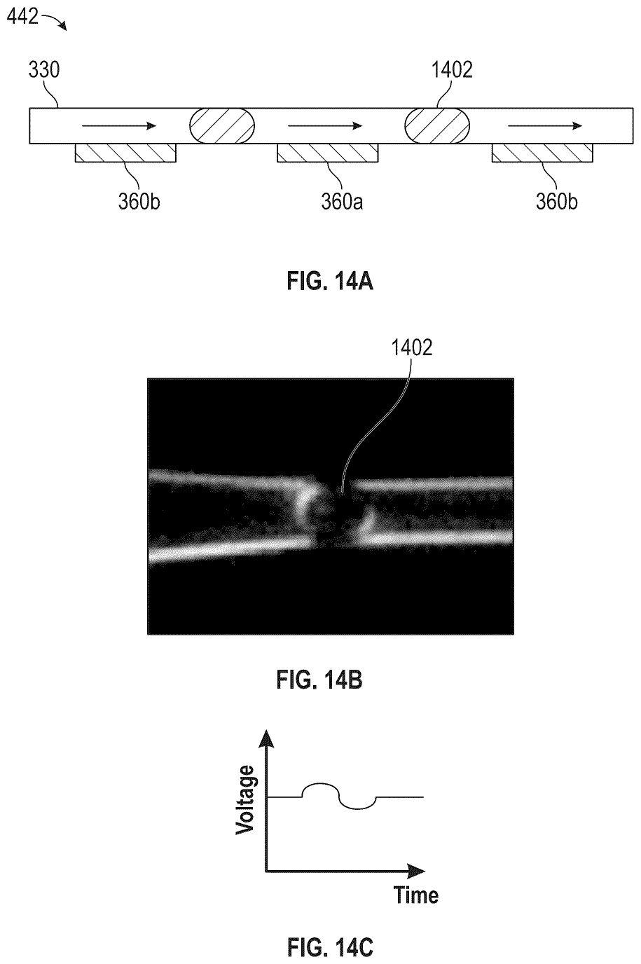

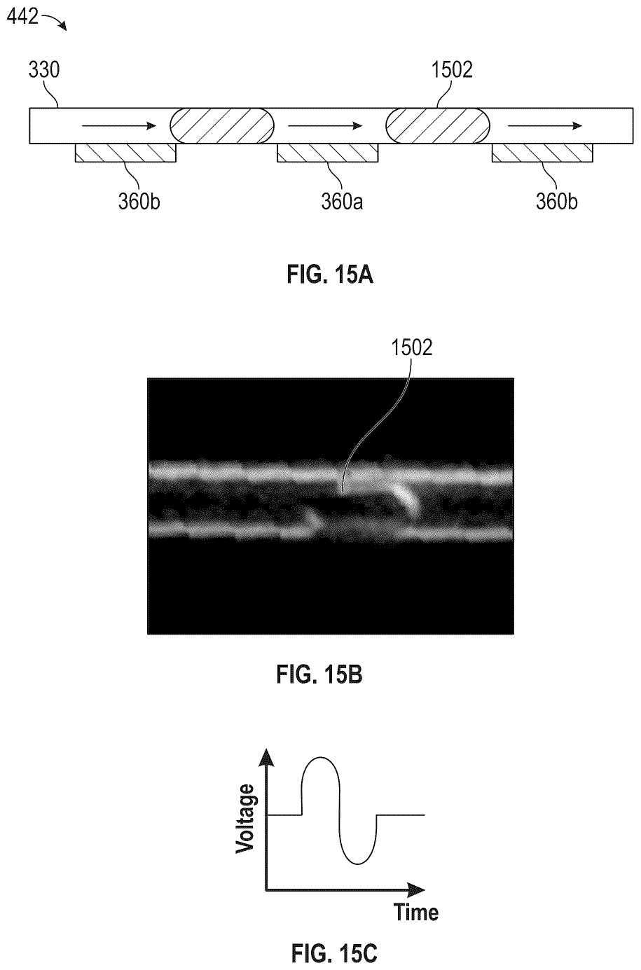

FIGS. 14A-14C illustrate a red blood cell 1402 of a patient with a relatively high HbA1c level traveling through the microchannel 330. FIGS. 15A-15C illustrate a red blood cell 1502 of a patient with a relatively low HbA1c level traveling through the microchannel 330. As cells travel through the microchannel 330, fluidic shear stress can cause the cells to elongate while traveling therethrough. As discussed further herein, the level of cell elongation can be measured to determine various characteristics of the cell.

FIGS. 14A and 15A illustrate the red blood cells 1402 and 1502, respectively, at two different positions each along the first detection region 442 (e.g., between the electrodes 360). As shown in FIG. 14A, when the red blood cell 1402 is positioned halfway between two adjacent electrodes 360, the red blood cell 1402 does not reach either electrode 360, indicating relatively low cell elongation. By contrast, as shown in FIG. 15A, when the red blood cell 1502 is positioned halfway between two adjacent electrodes 360, the red blood cell 1502 extends closer to either electrode 360 than the red blood cell 1402, indicating relatively high cell elongation. FIGS. 14B and 15B further illustrate the difference in cell elongation levels between the cells 1402, 1502. Compared to the cell 1402, the cell 1502 is more elongated.

The cell elongation level is a function of the deformability of the cell, which is affected by the glycation level of the patient. Glycated red blood cells (e.g., the cell 1402) are relatively rigid due to the glucose molecule attached thereto, resulting in low deformability and are thus associated with low cell elongation levels. On the other hand, normal or non-glycated red blood cells (e.g., the cell 1502) are relatively pliable, resulting in high deformability and are thus associated with high cell elongation levels. In some embodiments, the system can use the measurements or related effects of elongation for each cell to normalize the glycation measurements.

FIGS. 14C and 15C illustrate graphs of phase shift signal plots (e.g., measured as discussed above with reference to FIGS. 12A-12E) for the red blood cells 1402, 1502. As shown, while both signal plots are generally sinusoidal in shape, they have different amplitudes. FIG. 14C shows that the cell 1402 (e.g., glycated red blood cell) traveling through the microchannel 330 results in a relatively small amplitude, while FIG. 15C shows that the cell 1502 (e.g., non-glycated red blood cell) traveling through the microchannel 330 results in a relatively large amplitude. Therefore, in some embodiments, the amplitude of the measured phase shift signal can be processed to determine glycation levels of patients.

In some embodiments, phase shift signal amplitudes, and thus cell elongation, are measured at the first detection region 442. Because the second detection region 444 is sized to compress red blood cells, as discussed above with reference to FIGS. 4, 7, and 8, the resultant cell compression may attenuate differences between red blood cells from different patients, making measurements, comparison, etc. more difficult. By contrast, because the first detection region 442 is sized to avoid compressing or minimally compress red blood cells, the differences between red blood cells from different patients can be more apparent and easier to measure for subsequent analysis. In some embodiments, phase shift signal amplitudes, and thus cell elongation, are also measured at the second detection region 444, and the data can be normalized.

As an illustrative example, the dimensions of the microchannel at the first detection region can be greater than the corresponding dimensions of the human RBCs. As such, the RBCs can experience forces from the surrounding fluid (e.g., electrolyte and the liquid portion of the sample) as generated by the capillary action. The resulting computations regarding shape/speed can serve as a basis for normalizing the measurements obtained at the second detection region for the same RBC and the corresponding computations. In some embodiments, in normalizing the measurement for each RBC, the system can compute a ratio between the inlet and outlet speeds.

FIG. 16 is a graph illustrating normalized velocities of red blood cells traveling through the microchannel 330 from patients with different HbA1c levels. As discussed above, the velocity or speed of red blood cells traveling through the microchannel 330 can change depending on the rigidity of the cells and environmental and/or experimental factors. Moreover, without an active pumping mechanism to control the flow rate, the cartridge 204 may be more susceptible to variability in the velocity given the passive movement mechanism of the microchannel 330. Further, velocity, whether the inlet velocity, the outlet velocity, the total velocity, etc., is generally affected by environmental factors. Comparing the velocities at different points in the microchannel 330, such as by calculating a ratio between the speeds across the first detection region 442 and the second detection region 444, can remove or reduce the effect/influence of one or more of the variability factors, thereby increasing or highlighting the effect of the rigidity of the cells in the normalized data.

FIG. 16 plots the outlet/inlet velocity ratios corresponding to a first set 1610 of red blood cells from a patient with a relatively high HbAlc level (e.g., 12.5%), and corresponding to a second set 1620 of red blood cells from a patient with a relatively low HbA1c level (e.g., 5.6%). The horizontal axis represents the amplitude of the signal, discussed above with reference to FIGS. 14C and 15C. Linear regression can be performed on the first set 1610 and the second set 1620 to obtain plots 1614 and 1624, respectively. As shown, the plot 1614 has a steeper slope than the plot 1624, and is lower than the plot 1624 on the right side of the graph (e.g., for relatively larger difference signal amplitudes). In other words, red blood cells from patients with relatively high HbA1c levels tend to have lower outlet/inlet velocity ratios than red blood cells from patients with relatively low HbA1c levels for similar phase shift signal amplitudes. This may be attributed to the fact that due to their higher rigidity, glycated red blood cells generate more friction with the microchannel 330 when traveling therethrough, thus slowing down more than non-glycated red blood cells between the first detection region 442 and the second detection region 444. Dotted ovals 1612 and 1622, overlaid on the graph centered along plots 1614 and 1624, respectively, further illustrate that the first set 1610 and the second set 1620 exhibit different slopes on the graph.

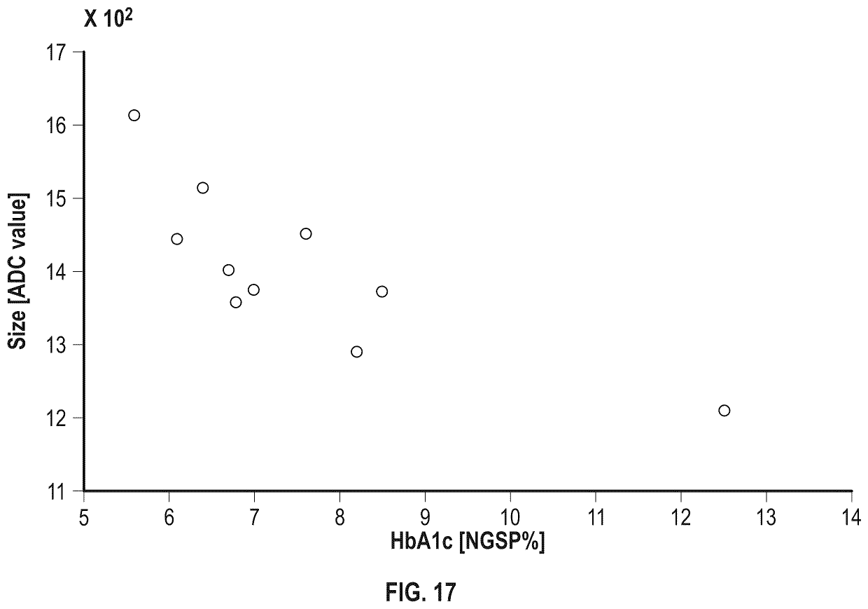

FIG. 17 is a graph illustrating correlation between HbAlc levels (the horizontal axis) and elongation sizes (measured in Analog to Digital Converter (ADC) value or mV) of red blood cells (vertical axis) traveling through the microchannel 330. As shown, red blood cells from patients with higher HbA1c levels can tend to create phase shift signals with smaller amplitudes. As discussed above with reference to FIGS. 14C and 15C, the smaller amplitudes can be a result of the reduced deformability of glycated red blood cells. Therefore, in some embodiments, the elongation sizes of red blood cells can be used to determine the HbA1c levels of patients.

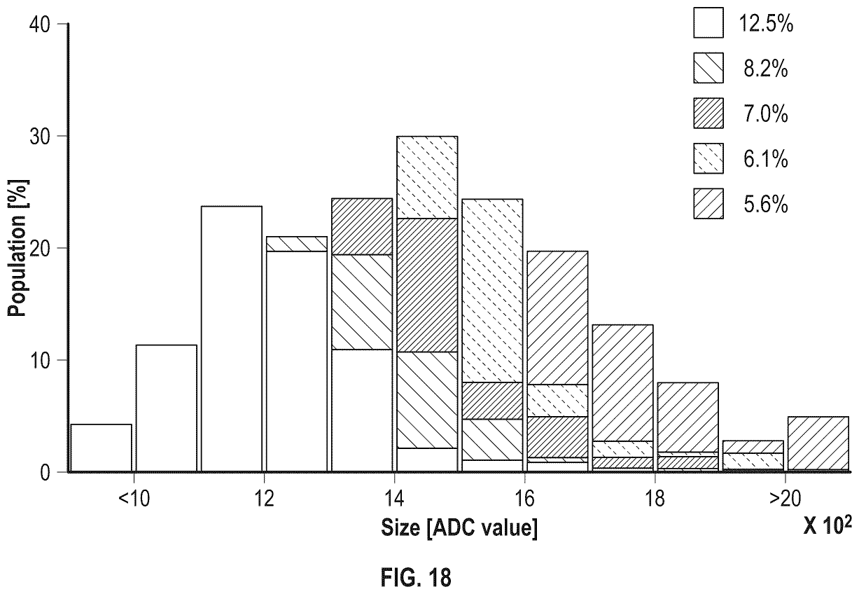

FIG. 18 is a graph illustrating distribution of elongation sizes of red blood cells from patients with different HbA1c levels. As shown, data from five different patients having different HbA1c levels (5.6%, 6.1%, 7.0%, 8.2%, and 12.5%) are plotted on the graph with cell elongation size (measured in ADC value) on the horizontal axis and distribution percentage on the vertical axis. As shown, red blood cells from patients with relatively higher HbA1c levels tend to exhibit smaller phase shift signal amplitudes, while red blood cells from patients with relatively lower HbA1c levels tend to exhibit larger phase shift signal amplitudes. As discussed above with reference to FIGS. 14C and 15C, glycated red blood cells tend to have reduced deformability and elongation, leading to smaller phase shift signal amplitudes.

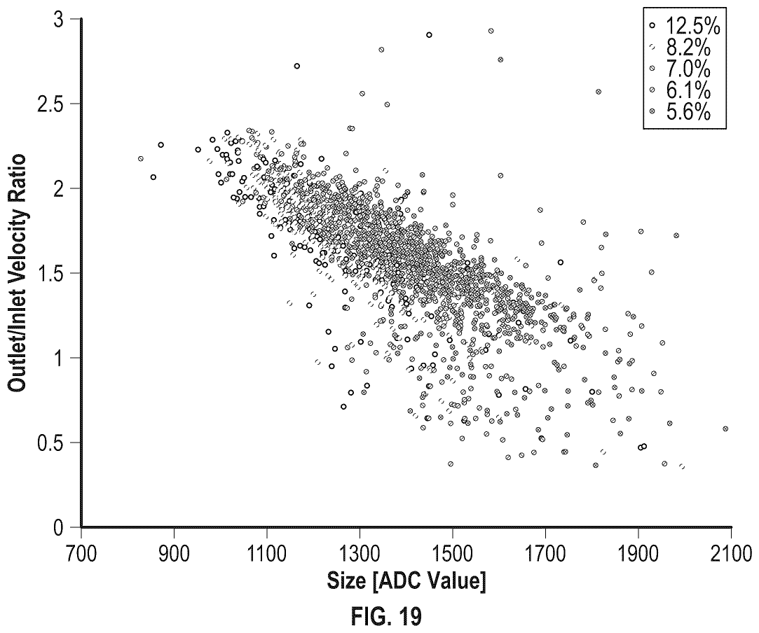

FIG. 19 is a graph illustrating correlation between HbA1c levels, normalized velocities, and elongation sizes of red blood cells traveling through the microchannel 330. As shown, data from five different patients having different HbA1c levels (5.6%, 6.1%, 7.0%, 8.2%, and 12.5%) are plotted on the graph with cell elongation size (measured in ADC value) on the horizontal axis and outlet/inlet velocity ratio on the vertical axis. As shown, red blood cells from patients with relatively higher HbA1c levels tend to exhibit smaller phase shift signal amplitudes and smaller outlet/inlet velocity ratios, while red blood cells from patients with relatively lower HbA1c levels tend to exhibit larger phase shift signal amplitudes and larger outlet/inlet velocity ratios. Therefore, measured phase shift signal amplitudes and/or outlet/inlet velocity ratios can be used to determine patients' HbA1c levels.

Referring to FIGS. 18 and 19, because the characteristics of each cell are analyzed and plotted together on graphs, even if the blood sample is diluted, the analysis result is expected to be accurate and reliable as long as a sufficient number of red blood cells (e.g., at least 100 cells) pass through the microchannel 330. Also, this method of plotting the characteristics of multiple cells together can eliminate or at least reduce errors associated with sampling volume.

In some embodiments, a formula using outlet/inlet velocity ratios and/or phase shift signal amplitudes as inputs is used to output a patient's HbA1c (or other glycation) level. In some embodiments, the formula can use either the outlet/inlet velocity ratios or the phase shift signal amplitudes, but not both, when under certain conditions, and use both the outlet/inlet velocity ratios and the phase shift signal amplitudes when under other conditions. For example, the formula may initially determine an HbA1c level estimate based only on the outlet/inlet velocity ratios. If the estimate does not exceed a certain threshold, the initially determined estimate can be the final output of the formula. If, however, the estimate exceeds the certain threshold, the formula may discard the estimate and recalculate the HbA1c level via a multi-variable analysis using both the outlet/inlet velocity ratios and the phase shift signal amplitudes.

Regarding the data measurements discussed above, assumptions made can include that (i) the red blood cells are completely symmetric in shape and in electrical properties (e.g., ions are uniformly distributed in the cytosol), (ii) the red blood cells do not undergo shape changes as they pass through a detection region (e.g., do not change in shape between times t₁ and t₃ within the first detection region 442), and/or (iii) the phase shift signal exhibits peaks and troughs when the red blood cell is located at the midpoints between two adjacent electrodes. For example, abnormalities in the phase shift signal, such as asymmetric amplitudes, can be excluded or differently accounted for when analyzing the data. In some embodiments, one or more of these assumptions are not made and the analyte level measuring system 102 can detect, for example, anemia in patients by detecting asymmetries in the measured phase shift signal.

Moreover, in some embodiments, the analysis apparatus 206 can identify error conditions (e.g., two red blood cells overlapping within the microchannel 330) by detecting signal measurements that deviate from expected values. For example, the first region electrodes 360b may detect two separate instances of cell travel, indicating two red blood cells entering the first detection region 442 separately, but the second region electrodes 360c may detect only one instance of cell travel within a certain period of time. The analysis apparatus 206 can determine that the two red blood cells stuck together while traveling from the first detection region 442 and the second detection region 444, and discard those measurement results accordingly.

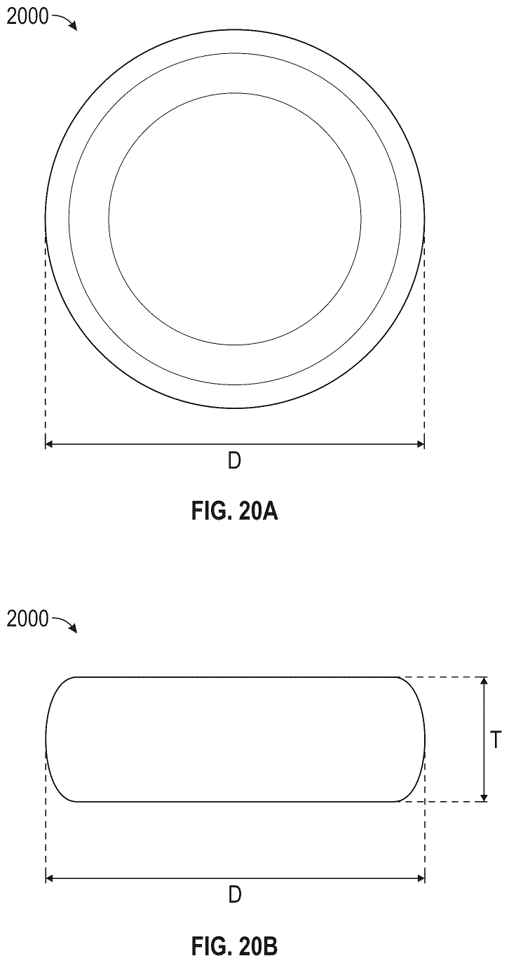

FIGS. 20A and 20B are top and side views, respectively, of an average red blood cell 2000. Referring to FIGS. 20A and 20B together, a red blood cell has a generally disc shape having a width or diameter D and a height or thickness T. In particular, the average red blood cell 2000 can have a diameter D of about 7-8 μm and a thickness T of about 2.5 μm. Accordingly, as discussed in further detail herein, by sizing a particular dimension of a microchannel to be smaller than a dimension the of the average red blood cell 2000, the microchannel can compress the red blood cell 2000 in a desired direction (e.g., along the diameter D or the thickness T).

Also, red blood cells, like most other biological matter, have viscoelastic properties. In particular, when a red blood cell is compressed (e.g., by the walls of a microchannel), the red blood cell initially deforms slowly due to its viscous properties. Once the red blood cell is compressed for a sufficient period of time and/or by a sufficient degree, only the elastic properties of the red blood cell may remain. This time-dependent behavior of red blood cells can be important to account for when determining health characteristics of users based on their red blood cells. For example, a person's glycated hemoglobin levels affects the cytoskeletal structure of red blood cells, which in turn governs the elastic response of red blood cells. On the other hand, the fluid content inside red blood cells governs the viscous resistance exhibited by red blood cells. Therefore, in order to accurately measure the user's glycated hemoglobin level, it can be important to isolate the elastic response such as by compressing the red blood cell for a sufficient period of time and/or by a sufficient degree until only the clastic response remains.

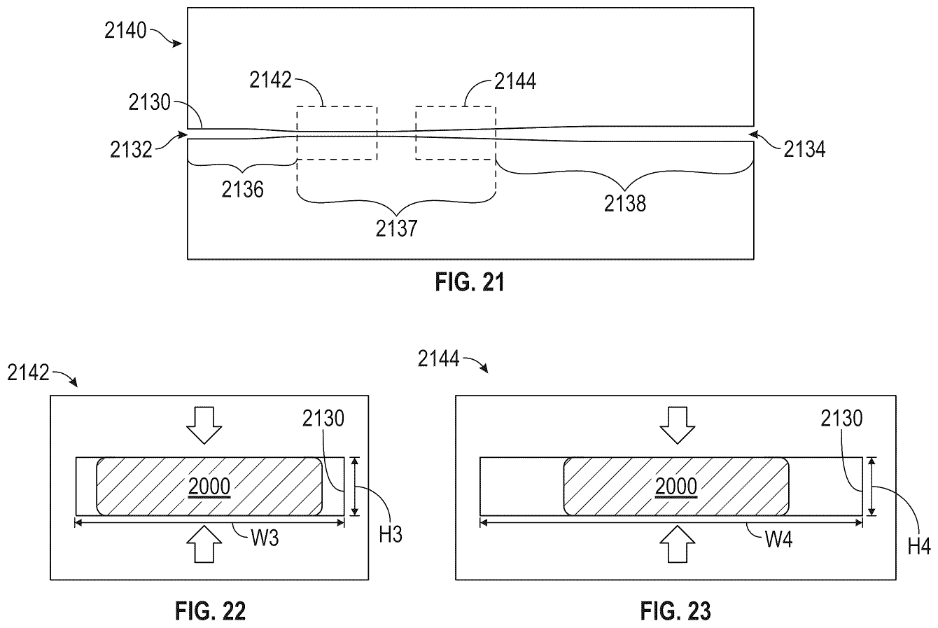

FIG. 21 is a partially schematic plan view of an observation window 2140 of a sample-testing cartridge configured in accordance with some embodiments of the present technology. Other components of the sample-testing cartridge, such as electrodes (e.g., the electrodes 360 of FIG. 3), are omitted for illustrative purposes only. As shown, the observation window 2140 includes a microchannel 2130 extending between a first end 2132 (e.g., an inlet of the microchannel 2130) and a second end 2134 (e.g., defining the boundary between the observation window 2140 and a capillary action inducement region (not shown)). The microchannel 2130 can have an upstream viscosity-elimination section 2136, a downstream measurement section 2137, and a downstream outflow section 2138. The downstream measurement section 2137 can have (i) a first detection region 2142 positioned between the upstream viscosity-elimination section 2136 and the downstream outflow section 2138 (or, more generally, between the first end 2132 and the second end 2134), and (ii) a second detection region 2144 positioned between the first detection region 2142 and the outflow section 2138 (or, more generally, between the first detection region 2142 and the second end 2134).

The microchannel 2130 can be configured to compress cells in one direction or in multiple directions. In some embodiments, the microchannel 2130 can compress cells to reduce both the width or diameter and the height or thickness of the cell. This multidirectional compression can cause elongation of the red blood cell in the direction of travel. In some embodiments, the microchannel 2130 is configured to compress a red blood cell in a single direction, such as along the cell's thickness, diameter, or the like. In embodiments that compress the thickness of the cell, the microchannel 2130 can cause a reduction of the cell's thickness by at least 1%, 2%, 3%, 4%, 5%, 10%, 15%, 21%, 25%, 30%, 35%, 45%, or 50%.

In operation, like the microchannel 330 described above with reference to FIGS. 3-8, the microchannel 2130 can receive one or more red blood cells (or other particulate) entering via the first end 2132 (e.g., from the cavity 322), direct the red blood cells through each of the three sections 2136, 2137, 2138, and to the second end 2134. While the three sections 2136, 2137, 2138 are illustrated with varying widths, in some embodiments, the three sections 2136, 2137, 2138 can have substantially the same or similar heights (dimension into the page). In particular, cach of the three sections 2136, 2137, and/or 2138 can have a height sized to compress individual red blood cells in the direction of their thickness.

For example, the upstream viscosity-elimination section 2136 (also referred to herein as “the upstream transient characteristic reduction section”) can have a height of about 1.6 μm, 1.8 μm, 2 μm, 2.2 μm, 2.4 μm, or 1.6-2.4 μm (e.g., smaller than the thickness T of the average red blood cell 2000 of FIG. 20B). Also, the upstream viscosity-elimination section 2136 can have a length of about 10 μm, 25 μm, 50 μm, 75 μm, 100 μm, 200 μm, 300 μm, 400 μm, 500 μm, 1,000 μm, or between 10-1,000 μm. The length of the upstream viscosity-elimination section 2136 can selected depending on the desired time period of cell compression. Accordingly, by being sized to vertically compress red blood cells and by extending a sufficient length along the microchannel 2130, the upstream viscosity-elimination section 2136 is expected to substantially eliminate the time-dependent (e.g., viscous) properties of red blood cells such that only the non-time-dependent or steady state (e.g., elastic) properties thereof remain. In other words, by compressing red blood cells when they enter the microchannel 2130, the upstream viscosity-elimination section 2136 can enable the downstream measurement section 2137 to measure parameters (e.g., cell speed/velocity, phase shift signal amplitude) affected by the remaining elastic properties without being affected by viscous properties of the red blood cell. As discussed above with reference to FIGS. 20A and 20B, viscous properties may be unrelated to health characteristics of users.

FIG. 22 is a cross-sectional view of the microchannel 2130 at the first detection region 2142. As shown, the first detection region 2142 can have a generally rectangular cross-section with a width W3 and a height H3. The width W3 can be sized to avoid laterally compressing the average red blood cell 2000. As noted above with reference to FIGS. 20A and 20B, the average red blood cell 2000 can have a width of about 7-8 μm. Thus, for example, the width W3 can be about 9 μm, 10 μm, 11 μm, 12 μm, 13 μm, or 9-13 μm (e.g., about 11.5 μm). The height H3 can be sized to vertically compress the average red blood cell 2000. As noted above with reference to FIGS. 20A and 20B, the average red blood cell 2000 can have a height of about 2.5 μm. Thus, for example, the height H3 can be about 1.6 μm, 1.8 μm, 2 μm, 2.2 μm, 2.4 μm, or 1.6-2.4 μm. The width W3 and/or the height H3 can be constant or can vary within the first detection region 2142.

FIG. 23 is a cross-sectional view of the microchannel 2130 at the second detection region 2144. As shown, the second detection region 2144 can have a generally rectangular cross-section with a width W4 and a height H4. The width W4 can be sized to avoid laterally compressing an average red blood cell 2102, and can be larger than the width W3 of the first detection region 2142. Thus, for example, the width W4 can be about 26 μm, 28 μm, 30 μm, 32 μm, 34 μm, or 26-34 μm. The height H4 can be sized to vertically compress the average red blood cell 2102. Thus, for example, the height H4 can be about 1.6 μm, 1.8 μm, 2 μm, 2.2 μm, 2.4 μm, or 1.6-2.4 μm. The width W4 and/or the height H4 can be constant or can vary within the first detection region 2142.

Referring to FIGS. 21-23 together, the configuration of the microchannel 2130 can be selected based on the target cell deformation and can have other cross-sectional shapes such as a polygonal shape, a rounded-polygonal shape, a rectangular shape, a square shape, an elliptical shape, a round shape, and/or the like. The cross-sectional shape and the dimensions of the microchannel 2130 can be selected based on, for example, desired mechanical compression of the cell, characteristics of the cell to be measured, or the like.

Referring to FIGS. 22 and 23, it can generally be desirable to have a relatively large width in each of the first detection region 2142 and the second detection region 2144. For example, unidirectional compression of red blood cells (e.g., compressing along their thicknesses only, as opposed to compressing along both their thicknesses and widths) can facilitate subsequent analyses for reasons described in greater detail below (e.g., reduced need for correcting voltage reading variability). Also, as described in greater detail herein, the compression (e.g., amount of compression, number of directions of compression, etc.) can be selected based on the target flow rate, the target degree of alteration or deformation of the cells, and/or the like. As another example, if the width is too small, the cells can experience multidirectional compression (e.g., both vertical and lateral compression) and/or the associated flow rate can be low enough to cause (i) a relatively rigid cell to travel slowly and (ii) subsequent, more pliable cells to catch up to and stick with the first, relatively rigid cell. As previously mentioned, two cells traveling together across either detection region can cause an error condition. On the other hand, if the width is too large, two cells may be able to travel together in parallel (e.g., side by side) through the microchannel. Accordingly, in the illustrated embodiment, the width W3 of the first detection region 2142 can be less than the summed width of two average red blood cells to prevent or at least reduce the likelihood of two red blood cells entering the first detection region 2142 simultaneously (e.g., in parallel, side by side). In contrast, the W4 of the second detection region 2144 can be larger than the width W3 to prevent or at least reduce the likelihood of cells sticking together in series, as discussed above.

Also, in some embodiments, the first detection region 2142 can be shorter in length than the second detection region 2144 to balance between (i) avoiding having cells traveling together in parallel, which favors the microchannel having a relatively smaller width, at least closer to the inlet (e.g., at the first detection region 2142) and (ii) avoiding having cells traveling together in series, which favors the microchannel having a relatively larger width. Accordingly, by minimizing the length of the first detection region 2142 having the relatively smaller width, the microchannel 2130 can achieve both goals of avoiding having cells traveling together in series or in parallel. In some embodiments, the length of the first detection region 2142 can be no more than 140 μm, 120 μm, 100 μm, 80 μm, or between 80-140 μm to provide sufficient space for a set of three electrodes (see, e.g., FIG. 5).

Continuing to refer to FIGS. 21-23 together, the microchannel 2130, at both the first detection region 2142 and the second detection region 2144, is sized to vertically compress red blood cells, but not laterally compress red blood cells. This is expected to be advantageous for several reasons. First, there is inherent variation in size among cells, and larger cells are expected to travel through a microchannel more slowly than smaller cells. Thus, it can be important to compensate for this cell size variation and thereby normalize the data for subsequent data analysis. One method of compensation is to estimate the cell size based on voltage readings, as the voltage reading can have a positive correlation (e.g., can be proportional) with cell size. Voltage readings, however, can vary significantly between different sensor systems (e.g., due to circuit component tolerances). Correcting this would require individualized calibration of sensor systems during the manufacturing process, which can be expensive, time-consuming, and/or prone to error. Variation in size can be significant when considering the lateral dimension (e.g., width, diameter) of laterally compressed cells. In contrast, variation in size can be much smaller when considering the vertical dimension (e.g., height, thickness) of vertically compressed cells. In other words, variation in cell size is more pronounced in cell width than in cell height. Accordingly, the microchannel 2130, by vertically compressing cells as opposed to laterally compressing cells, can eliminate or at least reduce the need for individualized calibration of sensor systems, thereby saving time, cost, etc.

Second, the width of a microchannel can have a manufacturing tolerance of, for example, about ±1 μm while the height of the microchannel can have a manufacturing tolerance of, for example, about ±0.1 μm. In some embodiments, this different in tolerance can be attributed to the manufacturing technique used (e.g., polyimide patterning, spin coating). Accordingly, because the height of the microchannel 2130 can be more precisely set than the width, microchannels sized to vertically compress cells can do so in a more consistent manner than microchannels sized to laterally compress cells, resulting in more consistent and accurate data analysis and measurements.

In some embodiments, the entirety (or at least a substantial portion) of the microchannel 2130 can have the same height. As aforementioned, the upstream viscosity-elimination section 2136 can be sized to cause deformation of red blood cells for a sufficient length of time to reduce or eliminate time-dependent properties (e.g., viscosity-related properties) that affect measurement of non-time dependent properties (e.g., elastic properties) of the cells. The length of time in which a cell is traveling along the upstream viscosity-elimination section 2136 can be equal to or greater than 0.1 second, 0.2 seconds, 0.3 seconds, 0.5 seconds, 1 seconds, 2 seconds, or the like. The length of time can be selected based on the amount of deformation of the red blood cell. To calibrate the system, cells with known characteristics (e.g., known glycated hemoglobin levels) can be passed along the microchannel 2130 at various lengths until viscosity-related measurements can be substantially eliminated.

In some embodiments, the height H3 of the first detection region 2142 and the height H4 of the second detection region 2144 can be generally similar (e.g., about 2 μm). In some embodiments, the height H3/H4 is selected such that the thickness of the cell is compressed by at least, for example, 5%, 10%, 21%, 30%, 40%, or ranges encompassing such percentages. In some applications, the microchannel 2130 can compress the red blood cell a sufficient amount to cause substantially the entire upper and lower concave faces to lay flat against the upper and lower surfaces of the microchannel 2130. This can allow for consistent movement along the microchannel passageway. In some embodiments, the entirety or the portion of the microchannel 2130 extending between the first end 2132 and the second end 2134 can have a constant height sized to vertically compress cells (e.g., about 2 μm). This is expected to be advantageous for several reasons. First, as previously discussed, cells, like many other biological materials, are viscoelastic. Thus, when they are compressed by a force, cells initially deform slowly due to their viscous properties, then once compressed (e.g., by a threshold amount for a sufficient length of time), only their elastic restoring force remains. In the case of red blood cells, the initial viscous resistance to compression is primarily governed by the fluid content inside the red blood cells, while the elastic response to compression is primarily governed by the cytoskeletal structure of the red blood cells, which in turn is affected by the glycated hemoglobin (HbA1c) levels of the red blood cells. Therefore, it can be desirable to compress red blood cells prior to entering the first detection region 2142 such that the electrodes (not shown) at both the first detection region 2142 and the second detection region 2144 measure red blood cell movement affected by their glycated hemoglobin levels, and not affected by (or at least not significantly affected by) the fluid content therein. Accordingly, by having the microchannel 2130 vertically compress cells at the first end 2132 (or other region upstream of the first detection region 2142), the measurements can be focused on determining the glycated hemoglobin levels without being significantly affected by other, non-relevant factors (e.g., viscosity).

In some embodiments, the upstream viscosity-elimination section 2136 is sized to compress red blood cells and the downstream measurement section 2137 is sized to keep the red blood cells compressed to measure characteristics of the cells. The measured characteristics can be primarily affected by cell stiffness (or elastic modulus). By reducing the viscous behavior of the cells, at least 80%, 90%, 95%, 98%, 99%, or about 100% of the measured “stiffness” of the cells can be attributable to the elastic modulus of the cells rather than other non-relevant factors. As such, the microchannel 2130 enables measurement of the steady-state characteristics for increased measurement accuracy. In some procedures, the effects of the viscosity of individual cells can be reduced by a sufficient amount to effectively eliminate viscosity effects that measurably affect deformation-based measurements of the cell. This results in any measurable stiffness attributable to viscosity being substantially eliminated.

Second, because cells are vertically compressed by a constant degree along the length of the microchannel 2130 extending between the first end 2132 and the second end 2134, the effect of flow rate variability can be eliminated or at least reduced. For example, without uniform cell compression, cells passing through regions with a relatively high flow rate may deform by different degrees compared to cells passing through regions with a relatively low flow rate. Such variation in deformation can introduce measurement errors. In contrast, the microchannel 2130 having a uniform height throughout can help ensure that the cells are compressed and thus deformed consistently when passing through each of the first detection region 2142 and the second detection region 2144, resulting in increased measurement accuracy.

Furthermore, in some embodiments, the first detection region 2142 having the relatively smaller width W3 has a relatively short length to help minimize the impact of cells on other cells traveling through the microchannel 2130. For example, a cell having a relatively high glycation level can move more slowly through the narrow first detection region 2142, thereby obstructing fluid flow and affecting the speed of neighboring (e.g., subsequent) cells traveling through the microchannel 2130. This can lead to inaccurate measurements, as each cell ideally yields its own independent data point(s). Accordingly, the first detection region 2142 that is relatively narrow can have a relatively short length to minimize or reduce the portion of the microchannel 2130 expected to cause the greatest mechanical stress and/or flow disruption to cells.

Moreover, while each of the first detection region 2142 and the second detection region 2144 can have its own set of electrodes (e.g., three electrodes) for independent measurement, in some embodiments, only measurements from either region is used for determining the glycated hemoglobin level or other particulate characteristic. For example, only measurements taken from the first detection region 2142 can be used to estimate or otherwise determine a patient's HbA1c level. Given an output signal from a set of three electrodes at the first detection region 2142 (see, e.g., FIGS. 11-12E), the measurement circuit can use (i) the pulse width (e.g., the time passed between the peak and the trough of the signal) and (ii) the known distance that the three electrodes are spaced apart to determine the velocity of the cell passing through the first detection region 2142. The determined velocities corresponding to multiple different cells can be plotted, and the distribution can be used to determine the HbA1c level, as discussed above with reference to FIGS. 16-19.

In some embodiments, measurements from the second detection region 2144, based on the pulse width, amplitude, and/or the like, can be used to check for error conditions. For example, the velocity measured at the second detection region 2144 can be compared against the velocity measured at the first detection region 2142 to verify that the two velocities are within an expected range of ratios. If the discrepancy between the two velocities is significant, the sensor system may deem that particular cell to be associated with an error condition, and discard any measurements pertaining to that call. For example, in some embodiments, the ratio between (i) the speed of a given cell traveling across the first detection region 2142 and (ii) the speed of the given cell traveling across the second detection region 2144 can be expected to be about 1:1, 1:2, 1:3, or between 1:1-1:3. If the measured ratio is 1:20, 1:100, or other significantly different ratio, the measurements pertaining to that cell can be discarded as erroneous.

It is appreciated that features of the various embodiments discussed herein can be combined in various ways to form additional embodiments. For example, the sample-testing cartridge of FIG. 21 can be used in combination with any one or more of the analysis methodologies described above with reference to FIGS. 16-19, and is not limited to the methodology discussed above with reference to FIGS. 21-23. As another example, the sample-testing cartridge 214 of FIG. 3 can be used in combination with any one or more of the analysis methodologies described above with reference to FIGS. 21-23.

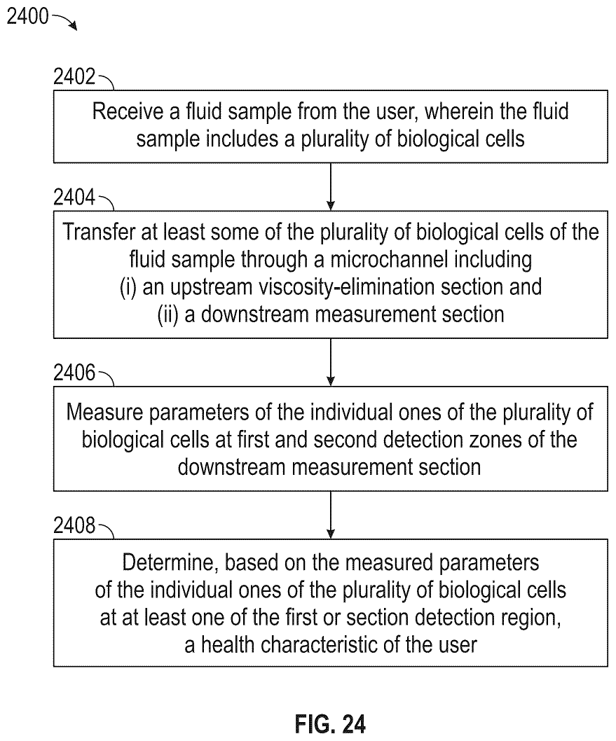

FIG. 24 is a flowchart illustrating a method 2400 for determining a health characteristic of a user in accordance with some embodiments of the present technology. While the steps of the method 2400 are described below in a particular order, one or more of the steps can be performed in a different order or omitted, and the method 2400 can include additional and/or alternative steps. Additionally, although the method 2400 may be described below with reference to the embodiments of the present technology described herein, the method 2400 can be performed with other embodiments of the present technology.

The method 2400 begins at block 2402 by receiving a fluid sample from the user. The fluid sample can include a plurality of biological cells. For example, the fluid sample can be a blood sample from the user containing red blood cells, among other cells.

At block 2404, the method 2400 continues by transferring at least some of the plurality of biological cells of the fluid sample through a microchannel. The microchannel can include (i) an upstream viscosity-elimination section sized to compress individual ones of the plurality of biological cells, and (ii) a downstream measurement section sized to keep the individual ones of the plurality of biological cells compressed to measure one or more elastic characteristics of the individual ones of the plurality of biological cells. In some embodiments, the microchannel is sized to compress the biological cells along the thicknesses of the biological cells without compressing along their diameters. Transferring the plurality of biological cells can include (i) transferring the plurality of biological cells one at a time across a first detection region of the microchannel, and (ii) transferring the plurality of biological cells one at a time across a second detection region of the microchannel located downstream of the first detection region. In some embodiments, each of the first detection region and the second detection region includes a set of electrodes (e.g., three electrodes).

At block 2406, the method 2400 continues by measuring parameters of the individual ones of the plurality of biological cells at each of the first detection region and the second detection region. In some embodiments, measuring comprises receiving output signals from the set of electrodes indicative of the individual ones of the plurality of biological cells traveling across the first detection region. In some embodiments, measuring comprises (i) measuring a first speed of respective biological cell traveling across the first detection region, (ii) measuring a second speed of the respective biological cell traveling across the second detection region, (iii) calculating a ratio between the second speed and the first speed, and (iv) measuring an amplitude of a phase shift signal pertaining to the respective biological cell at the first detection region or the second detection region.

At block 2408, the method 2400 continues by determining, based on the measured parameters of the individual ones of the plurality of biological cells at at least one of the first detection region or the second detection region, a health characteristic of the user. In some embodiments, determining comprises determining the health characteristic of the user based only on the output signals received from the set of electrodes at the first detection region. In some embodiments, determining further comprises (i) analyzing a pulse width of the output signal, (ii) determining a travel speed of the respective biological cell across the first detection region based on the analyzed pulse width and a distance between the set of electrodes, (iii) plotting a distribution of the determined travel speeds of the individual ones of the plurality of biological cells, and (iv) identifying which of a plurality of distributions, each corresponding to a different value of the health characteristic, matches the plotted distribution.

In some embodiments, determining comprises plotting the calculated ratios against the measured amplitudes of the individual ones of the plurality of biological cells to create a measured ratio-versus-amplitude plot, and identifying which of a plurality of ratio-versus-amplitude plots, each corresponding to a different value of the health characteristic, matches the measured ratio-versus- amplitude plot. In such embodiments, the plurality of biological cells can include a plurality of red blood cells, and the health characteristic can include a glycated hemoglobin level of the user. Also, in the plurality of ratio-versus-amplitude plots, higher glycated hemoglobin levels can be correlated with (i) lower ratios between the second speed and the first speed and (ii) lower amplitudes of the phase shift signal, and conversely, lower glycated hemoglobin levels can be correlated with (i) higher ratios between the second speed and the first speed and (ii) higher amplitudes of the phase shift signal.

In some embodiments, determining comprises determining an initial estimate of the health characteristic of the user based on the calculated ratios (e.g., of the second speed at the second detection region and the first speed at the first detection region) of the individual ones of the plurality of biological cells. If the initial estimate is below a predetermined threshold, the method 2400 can continue by outputting the initial estimate as the determined health characteristic of the user. On the other hand, if the initial estimate is above the predetermined threshold, the method 2400 can continue by (i) discarding the initial estimate, (ii) measuring, for each of the individual ones of the plurality of biological cells, an amplitude of a phase shift signal pertaining to the respective biological cell at the first detection region or the second detection region, (iii) calculating an updated estimate of the health characteristic of the user based on a multivariable analysis considering the calculated ratios and the measured amplitudes of the individual ones of the plurality of biological cells, and (iv) outputting the updated estimate as the determined health characteristic of the user.

In some embodiments, the method 2400 further comprises calculating a ratio between the first speed and the second speed, and determining that the calculated ratio is outside of a predetermined range of acceptable ratios. In such embodiments, determining may not be based on the first speed or the second speed of the one of the plurality of biological cells. In some embodiments, determining comprises determining the health characteristic of the user based on the measured parameters of at least 50, 75, 100, 200, 300, 500, 1,000, 2,000, 3,000, 5,000, or more of the plurality of biological cells.

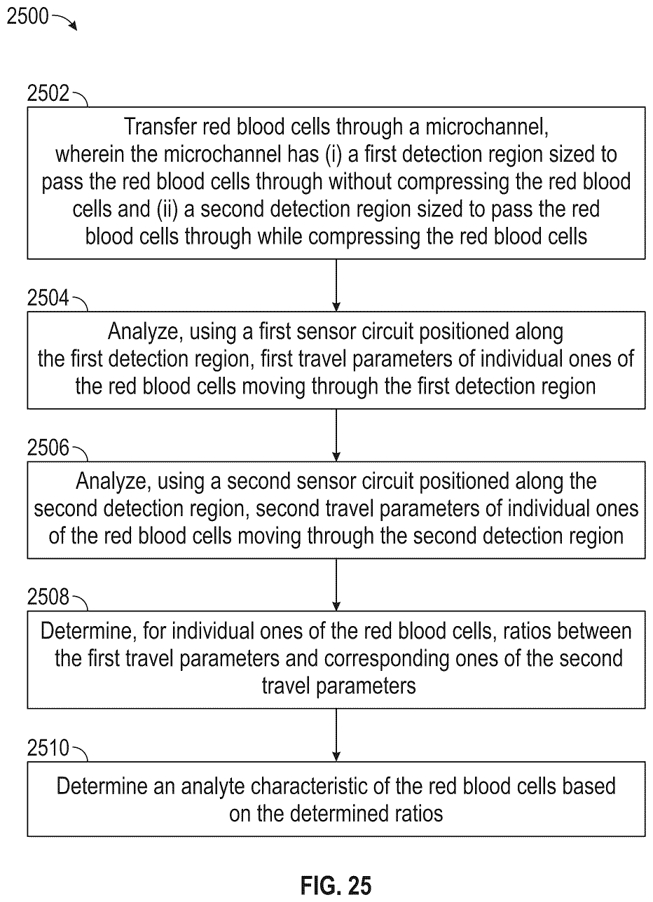

FIG. 25 is a flowchart illustrating a method 2500 for measuring a glycated hemoglobin level in accordance with some embodiments of the present technology. While the method 2500 is described below in a particular order, one or more steps can be performed in a different order or omitted, and the method 2500 can include additional and/or alternative steps. Also, although the method 2500 may be described below with reference to the embodiments described above herein, the method 2500 can be performed with other embodiments of the present technology.

The method 2500 begins at block 2502 by transferring red blood cells through a microchannel (e.g., the microchannel 330), wherein the microchannel has (i) a first detection region (e.g., the first detection region 442) sized to pass the red blood cells through without compressing the red blood cells and (ii) a second detection region (e.g., the second detection region 444) sized to pass the red blood cells through while compressing the red blood cells.

At block 2504, the method 2500 continues by analyzing, using a first sensor circuit positioned along the first detection region, first travel parameters (e.g., travel velocity) of individual ones of the red blood cells moving through the first detection region.

At block 2506, the method 2500 continues by analyzing, using a second sensor circuit positioned along the second detection region, second travel parameters (e.g., travel velocity) of individual ones of the red blood cells moving through the second detection region.

At block 2508, the method 2500 continues by determining, for individual ones of the red blood cells, ratios between the first travel parameters and corresponding ones of the second travel parameters.

At block 2510, the method 2500 continues by determining an analyte characteristic (e.g., glycated hemoglobin level, HbA1c percentage) of the red blood cells based on the determined ratios.

In some embodiments, the method 2500 further comprises analyzing, using the first sensor circuit, elongation levels of individual ones of the red blood cells moving through the first detection region. In such embodiments, determining an analyte characteristic of the red blood cells can be further based on the determined clongation levels. Also, analyzing elongation levels can comprise determining amplitudes of phase shift signals measured by the first sensor circuit.

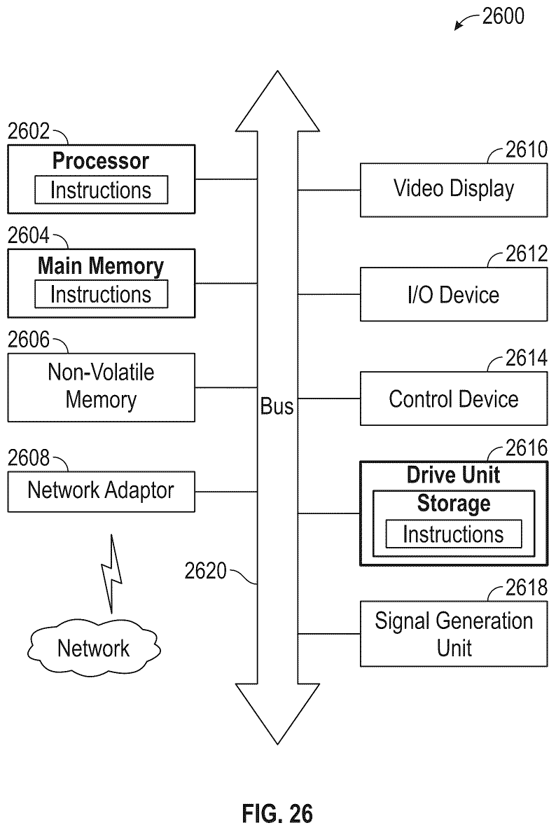

FIG. 26 is a block diagram illustrating an example of a processing system 2600 in which at least some operations described herein can be implemented. For example, a computing device (e.g., the analysis apparatus 106, one or more client computing devices 120, or a combination thereof of FIG. 1) may be implemented using the processing system 2600.

The processing system 2600 may include one or more central processing units 2602 (“processors”), main memory 2604, non-volatile memory 2606, network adapters 2608 (e.g., network interfaces), video displays 2610, input/output devices 2612, control devices 2614 (e.g., keyboard and pointing devices), drive units 2616 including a storage medium, and/or signal generation devices 2618 that are communicatively connected to a bus 2620. The bus 2620 is illustrated as an abstraction that represents one or more physical buses and/or point-to-point connections that are connected by appropriate bridges, adapters, or controllers. The bus 2620, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus (also referred to as “Firewire”).

The processing system 2600 may operate in the capacity of a server or a client machine in a client-server network environment, or as a peer machine in a peer-to-peer network environment. The processing system 2600 may be an analysis circuit within a medical device, a server, a personal computer, a tablet computer, a personal digital assistant (PDA), a mobile phone, a gaming console, a gaming device, a music player, a wearable electronic device, a network-connected (“smart”) device, a virtual/augmented reality system, or any other machine capable of executing a set of instructions (sequential or otherwise) that specify actions to be taken by the processing system 2600.

While the main memory 2604, the non-volatile memory 2606, and the storage medium (also called a “machine-readable medium”) are shown to be a single medium, the term “machine-readable medium” and “storage medium” should be taken to include a single medium or multiple media (e.g., a centralized or distributed database, and/or associated caches and servers) that store one or more sets of instructions. The term “machine-readable medium” and “storage medium” shall also be taken to include any medium that is capable of storing, encoding, or carrying a set of instructions for execution by the processing system 2600.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions) set at various times in various memory and storage devices in a computing device. When read and executed by the one or more processors, the instruction(s) cause the processing system to perform operations to execute clements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices, floppy and other removable disks, hard disk drives, optical disks (e.g., Compact Disk Read-Only Memory (CD ROMS), Digital Versatile Disks (DVDs)), and transmission-type media such as digital and analog communication links.

The network adapter 2608 enables the processing system to mediate data in a network with an entity that is external to the processing system through any communication protocol supported by the processing system and the external entity. The network adapter 2608 can include one or more of network adaptor cards, wireless network interface card, router, an access point, wireless router, switch, multilayer switch, protocol converter, gateway, bridge, bridge router, hub, digital media receiver, and/or a repeater.

The network adapter 2608 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

As described above, in some embodiments, the degree of glycation may be measured using changes in the physical characteristics of red blood cells due to the glycation. In some embodiments, systems that use the disclosed technology (e.g., calculating mechanical properties, such as stiffness or hardness, of each individual red blood cell based on their microchannel passage time) may determine the degree of glycation more stably in response to external and human factors compared to equipment using biochemical techniques. In some embodiments, the glycated hemoglobin level measuring system can detect minute electrical changes that occur due to the passage of red blood cells using a circuit configuration and determine the degree of glycation of the red blood cells. In some embodiments, the glycated hemoglobin level measuring system can be used directly for clinical diagnosis by correcting an initial calculation of the glycated hemoglobin level using an individual user's reference value.

The systems can store one or more analyte management programs, calibration routines, or protocols. In some embodiments, the analyte management program can indicate whether a measured analyte level is within a target or healthy range (e.g., HbA1c level of 4-6% of total hemoglobin). The HbA1c level can indicate the subject-specific effectiveness of blood glucose management over a period of time, such as one or more months preceding the analysis. If the subject has a higher level (e.g., HbA1c level greater than 8% of total hemoglobin), the subject could be diabetic or pre-diabetic. The subject can take steps to lower the HbA1c level to an acceptable target level (e.g., HbA1c level equal to or less than 5%, 6%, or 7% of total hemoglobin). The healthy range and target level can be inputted by the user, healthcare provider, or another source.

Furthermore, the glycated hemoglobin level measuring system can be implemented with a computer-readable storage medium or a similar device using, for example, software, hardware, or a combination thereof. In a hardware implementation, the glycated hemoglobin level measuring system can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing other functions. In some embodiments, the glycated hemoglobin level measuring system may be implemented by a control module itself. In a software implementation, one or more aspects of the glycated hemoglobin level measuring system, such as the procedures and functions described above, may be implemented as separate software modules. Each of the software modules may perform one or more functions and operations described in the present specification. Software code may be implemented in software applications written in a suitable programming language. The software code may be stored in a memory module and may be executed by the control module.

The embodiments, features, systems, devices, materials, methods and techniques described herein may, in some embodiments, be similar to any one or more of the embodiments, features, systems, devices, materials, methods and techniques described in the following:
Korean Patent Application No. 10-2021-0128520, filed Sep. 29, 2021, issued as Korean Patent No. 10-2439474;
International Application PCT/KR2021/018280, filed Dec. 3, 2021;
U.S. Application titled APPARATUS FOR MEASURING GLYCATION OF RED BLOOD CELLS AND GLYCATED HEMOGLOBIN LEVEL USING PHYSICAL AND ELECTRICAL CHARACTERISTICS OF CELLS, AND RELATED METHODS, filed on Dec. 9, 2022; Attorney Docket Number: 149800.8001.US01, and listing inventors: Ung-Hyeon Ko; Seung-Jin Kang; and Eun-Young Park, issued as U.S. Pat. No. 11,747,348;
International Application PCT/KR2022/019905, filed Dec. 8, 2022;
Korean Patent Application No. 10-2022-0031378, filed Mar. 14, 2022;
U.S. Application titled APPARATUS FOR MEASURING PROPERTIES OF PARTICLES IN A SOLUTION AND RELATED METHODS, filed on Dec. 9, 2022; Attorney Docket Number: 149800.8002.US00, and listing inventors: Ung-Hyeon Ko; Seung-Jin Kang; and Eun-Young Park, issued as U.S. Pat. No. 11,852,577; and
U.S. Application titled SAMPLE-TESTING SYSTEM FOR MEASURING PROPERTIES OF RED BLOOD CELLS, filed on Dec. 8, 2023; Attorney Docket Number: 149800.8003.US01, and listing inventors: Ung-Hyeon Ko; Seung-Jin Kang; and Eun-Young Park.

All of the above-identified patents and applications are incorporated by reference in their entireties. In addition, the embodiments, features, systems, devices, materials, methods and techniques described herein may, in certain embodiments, be applied to or used in connection with any one or more of the embodiments, features, systems, devices, or other matter.

### V. Examples

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.
1. A method for determining a health characteristic of a user, the method comprising:
receiving a fluid sample from the user, wherein the fluid sample includes a plurality of biological cells;
transferring at least some of the plurality of biological cells of the fluid sample through a microchannel including:
   an upstream viscosity-elimination section sized to compress individual ones of the plurality of biological cells, and
   a downstream measurement section sized to keep the individual ones of the plurality of biological cells compressed to measure one or more elastic characteristics of the individual ones of the plurality of biological cells;
measuring parameters of the individual ones of the plurality of biological cells at a first detection region of the downstream measurement section and a second detection region of the downstream measurement section; and
determining, based on the measured parameters of the individual ones of the plurality of biological cells at at least one of the first detection region or the second detection region, a health characteristic of the user.
2. The method of example 1 wherein each of the upstream viscosity-elimination section and the downstream measurement section is sized to compress the individual ones of the plurality of biological cells along their thicknesses.
3. The method of example 1 or example 2, wherein at least one of the first detection region or the second detection region is configured to measure stiffness of the individual ones of the plurality of biological cells, wherein at least 90% of the measured stiffness is attributable to an elastic modulus of the individual ones of the plurality of biological cells.
4. The method of any of examples 1-3, wherein the first detection region of the microchannel includes a set of electrodes, wherein measuring comprises receiving output signals from the set of electrodes indicative of the individual ones of the plurality of biological cells traveling across the first detection region, and wherein determining comprises determining the health characteristic of the user based only on the output signals received from the set of electrodes at the first detection region.
5. The method of example 4, wherein determining further comprises, for each of the individual ones of the plurality of biological cells:
analyzing a pulse width of the output signal; and
determining a travel speed of the respective biological cell across the first detection region based on the analyzed pulse width and a distance between the set of electrodes.
6. The method of example 5, wherein determining further comprises:
plotting a distribution of the determined travel speeds of the individual ones of the plurality of biological cells; and
identifying which of a plurality of distributions, each corresponding to a different value of the health characteristic, matches the plotted distribution.
7. The method of any of examples 1-6, wherein measuring comprises measuring (i) a first speed of one of the plurality of biological cells at the first detection region and (ii) a second speed of the one of the plurality of biological cells at the second detection region, and wherein the method further comprises:
calculating a ratio between the first speed and the second speed; and
determining that the calculated ratio is outside of a predetermined range of acceptable ratios,
wherein determining is not based on the first speed or the second speed of the one of the plurality of biological cells.
8. The method of any of examples 1-7, wherein measuring comprises, for each of the individual ones of the plurality of biological cells:
measuring a first speed of respective biological cell traveling across the first detection region;
measuring a second speed of the respective biological cell traveling across the second detection region;
calculating a ratio between the second speed and the first speed; and
measuring an amplitude of a phase shift signal pertaining to the respective biological cell at the first detection region or the second detection region.
9. The method of example 8, wherein determining comprises:
plotting the calculated ratios against the measured amplitudes of the individual ones of the plurality of biological cells to create a measured ratio-versus-amplitude plot; and
identifying which of a plurality of ratio-versus-amplitude plots, each corresponding to a different value of the health characteristic, matches the measured ratio-versus-amplitude plot.
10. The method of example 9, wherein the plurality of biological cells includes a plurality of red blood cells, wherein the health characteristic includes a glycated hemoglobin level of the user, and wherein, in the plurality of ratio-versus-amplitude plots:
higher glycated hemoglobin levels are correlated with (i) lower ratios between the second speed and the first speed and (ii) lower amplitudes of the phase shift signal,
lower glycated hemoglobin levels are correlated with (i) higher ratios between the second speed and the first speed and (ii) higher amplitudes of the phase shift signal.
11. The method of any of examples 1-10, wherein:
measuring comprises, for each of the individual ones of the plurality of biological cells:
   measuring a first speed of respective biological cell traveling across the first detection region;
   measuring a second speed of the respective biological cell traveling across the second detection region; and
   calculating a ratio between the second speed and the first speed, and
determining comprises:
   determining an initial estimate of the health characteristic of the user based on the calculated ratios of the individual ones of the plurality of biological cells;
   determining that the initial estimate is below a predetermined threshold; and
   outputting the initial estimate as the determined health characteristic of the user.
12. The method of any of examples 1-11, wherein:
measuring comprises, for each of the individual ones of the plurality of biological cells:
   measuring a first speed of respective biological cell traveling across the first detection region;
   measuring a second speed of the respective biological cell traveling across the second detection region; and
   calculating a ratio between the second speed and the first speed, and
determining comprises:
   determining an initial estimate of the health characteristic of the user based on the calculated ratios of the individual ones of the plurality of biological cells;
   determining that the initial estimate is above a predetermined threshold;
   discarding the initial estimate;
   measuring, for each of the individual ones of the plurality of biological cells, an amplitude of a phase shift signal pertaining to the respective biological cell at the first detection region or the second detection region;
   calculating an updated estimate of the health characteristic of the user based on a multivariable analysis considering the calculated ratios and the measured amplitudes of the individual ones of the plurality of biological cells; and
   outputting the updated estimate as the determined health characteristic of the user.
13. The method of any of examples 1-12, wherein determining comprises determining the health characteristic of the user based on the measured parameters of at least 100 of the plurality of biological cells.
14. A sample-testing cartridge for measuring a health characteristic of a user, the sample-testing cartridge comprising:
a substrate having a plurality of electrodes configured to be operably coupled to an analysis device;
a sensor body carried by the substrate and having a cavity configured to receive a biological fluid sample from a user containing a plurality of biological cells; and
a microchannel layer disposed between the substrate and the sensor body and having a microchannel, wherein the microchannel has (i) an inlet in fluid communication with the cavity, (ii) an outlet, (iii) a first detection region positioned between the inlet and the outlet, and (iv) a second detection region positioned between the first detection region and the outlet,
wherein the first detection region has (i) a first height sized to compress individual ones of the plurality of biological cells along thicknesses of the biological cells and (ii) a first width sized to avoid compressing individual ones of the plurality of biological cells along diameters of the biological cells, and
wherein the second detection region has (i) a second height sized to compress individual ones of the plurality of biological cells along thicknesses of the biological cells and (ii) a second width sized to avoid compressing individual ones of the plurality of biological cells along diameters of the biological cells, wherein the second width is different from the first width.
15. The sample-testing cartridge of example 14, wherein the second width is greater than the first width.
16. The sample-testing cartridge of example 14 or example 15, wherein the second height is substantially equal to the first height.
17. The sample-testing cartridge of any of examples 14-16, wherein the microchannel has a constant height between the inlet and the outlet.
18. The sample-testing cartridge of any of examples 14-17, wherein the first detection region has a first length, and wherein the second detection region has a second length greater than the first length.
19. The sample-testing cartridge of any of examples 14-18, wherein each of the first height of the first detection region and the second height of the second detection region is about 2 μm.
20. The sample-testing cartridge of any of examples 14-19, wherein the first width of the first detection region is between 9-13 μm, and wherein the second width of the second detection region is between 26-34 μm.
21. The sample-testing cartridge of any of examples 14-20, wherein a length of the first detection region is no more than 140 μm.
22. The sample-testing cartridge of any of examples 14-21, wherein each of the substrate and the sensor body is made of glass, and wherein the microchannel layer includes a polyimide patterning layer bonded to the sensor body via surface-level covalent bonding induced by a hot press of the substrate and the sensor body.
23. A method comprising:
transferring a plurality of biological cells of a fluid sample from a user through a microchannel including:
   an upstream transient characteristic reduction section configured to alter individual ones of the plurality of biological cells to reduce a transient characteristic of the individual ones of the plurality of biological cells, which would significantly affect measurement of a parameter of the cells, and
   a downstream measurement section configured to measure one or more steady state characteristics of the individual ones of the plurality of biological cells while maintaining the reduction of the transient characteristic of the individual ones of the plurality of biological cells; and
measuring the one or more steady state characteristics of the individual ones of the plurality of biological cells at a measurement section an of downstream measurement section.
24. The method of example 23, further comprising determining, based on the measuring of the one or more steady state characteristics, a health characteristic of the user.
25. The method of example 23 or example 24, further comprising using a first detection region and a second detection region of the downstream measurement section to measure the one or more steady state characteristics.
26. The method of any of examples 23-25, wherein the downstream measurement section include one or more energy emitting sensor assembles for measuring the one or more steady state characteristics based on energy passing through the individual ones of the plurality of biological cells.
27. A glycated hemoglobin level measuring system, the system comprising:
a sample testing cartridge that includes:
   a substrate having a microchannel extending between an inlet and an outlet, wherein
      the microchannel has an observation window between the inlet and the outlet, wherein the inlet is configured to receive a blood sample with red blood cells suspended therein;
   a first pair of electrodes on or embedded in the substrate, coupled to the observation window of the microchannel, and spaced along the observation window so as to define a first detection region having a first cross-sectional dimension greater than an average diameter of the red blood cells; and
   a second pair of electrodes on or embedded in the substrate, coupled to the observation window of the microchannel between the first detection region and the outlet, and spaced along the observation window so as to define a second detection region having a second cross-sectional dimension less than the average diameter of the red blood cells for compressing the red blood cells.
28. The system of example 27, wherein the microchannel has a capillary action inducement portion in which the microchannel extends in a serpentine pattern between the observation window and the outlet.
29. The system of example 27 or example 28, wherein the first cross-sectional dimension is between 8-20 μm.
30. The system of any of examples 27-29, wherein the second cross-sectional dimension is between 2-8 μm.
31. The system of any of examples 27-30, wherein the observation window has a narrowing section extending between the first detection region and the second detection region.
32. The system of any of examples 27-31, further comprising a controller programmed to determine one or more glycated hemoglobin levels based on red blood cell elongation.
33. A method for measuring a glycated hemoglobin level, the method comprising:
transferring red blood cells through a microchannel, wherein the microchannel has (i) a first detection region sized to pass the red blood cells through without compressing the red blood cells and (ii) a second detection region sized to pass the red blood cells through while compressing the red blood cells;
analyzing, using a first sensor circuit positioned along the first detection region, first travel parameters of individual ones of the red blood cells moving through the first detection region;
analyzing, using a second sensor circuit positioned along the second detection region, second travel parameters of individual ones of the red blood cells moving through the second detection region;
determining, for individual ones of the red blood cells, ratios between the first travel parameters and corresponding ones of the second travel parameters; and
determining an analyte characteristic of the red blood cells based on the determined ratios.
34. The method of example 33, further comprising:
analyzing, using the first sensor circuit, elongation levels of individual ones of the red blood cells moving through the first detection region,
wherein determining an analyte characteristic of the red blood cells is further based on the determined elongation levels.
35. The method of example 34, wherein analyzing elongation levels comprises determining amplitudes of phase shift signals measured by the first sensor circuit.
36. A glycated hemoglobin level measuring system, the system comprising:
a sample testing cartridge including a variable width channel configured to cause elongation of red blood cells traveling along the variable width channel; and
a controller programmed to determine one or more analyte characteristics of the red blood cells based on the elongation of the red blood cells.
37. The glycated hemoglobin level measuring system of example 36, wherein the controller is programmed to determine an elongation level based on deformation of one of the red blood cells caused by the variable width channel.
38. The glycated hemoglobin level measuring system of example 36 or example 37, wherein the controller is programmed to perform a cell elongation analysis based on one or more signals from at least one electrode positioned along the variable width channel.
39. The glycated hemoglobin level measuring system of any of examples 36-38, wherein the variable width channel has a red blood cell compression tapered region.
40. The glycated hemoglobin level measuring system of example 38, wherein the red-blood cell compression tapered region is positioned between a first detection region and a second detection region of the sample testing cartridge.
41. The glycated hemoglobin level measuring system of any of examples 36-40, wherein the variable width channel has a uniform width along at least one detection region to maintain a red blood cell elongation level in the at least one detection region.
42. The glycated hemoglobin level measuring system of any of examples 36-41, wherein the sample testing cartridge includes a capillary-action section in fluid communication with the variable width channel, wherein the capillary-action section is configured to maintain a sample flow rate along the variable width channel at or above a threshold sample flow rate while at least one red blood cell is elongated within the variable width channel.
43. The glycated hemoglobin level measuring system of example 42, wherein the capillary-action section is configured maintain the threshold sample flow rate through the variable width channel for a detection period of time.
44. The glycated hemoglobin level measuring system of example 42, wherein the threshold sample flow rate is sufficiently high to cause at least one red blood cell to traverse the variable width channel per minute.

### V. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

To the extent any material incorporated herein by reference conflicts with the present disclosure, the present disclosure controls. Where the context permits, singular or plural terms may also include the plural or singular term, respectively. For example, throughout this disclosure, the singular terms “a,” “an,” and “the” include plural referents unless the context clearly indicates otherwise. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, a step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing numerical values used in the specification and claims, are to be understood as being modified in all instances by the term “about.” Accordingly, unless indicated to the contrary, the numerical parameters set forth in the specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. The terms “about,” “approximately,” and “substantially” as used herein shall be interpreted to mean within ±10% of the stated value. Additionally, all ranges disclosed herein are to be understood to encompass the endpoints, and any and all subranges subsumed therein. For example, a range of “1 to 10” includes any and all subranges between (and including) the minimum value of 1 and the maximum value of 10 (e.g., any and all subranges having a minimum value of equal to or greater than 1 and a maximum value of equal to or less than 10, such as 5.5 to 10).

The disclosure set forth above is not to be interpreted as reflecting an intention that any claim or example requires more features than those expressly recited in that claim or example. Rather, as the preceding examples and the following claims reflect, inventive aspects lie in a combination of fewer than all features of any single foregoing disclosed embodiment. Thus, the preceding examples and the following claims are hereby expressly incorporated into the Detailed Description, with each claim standing on its own as a separate embodiment. This disclosure includes all permutations of the independent claims with their dependent claims.

What is claimed is:

1. A method for determining a health characteristic of a user, the method comprising:
receiving a fluid sample from the user, wherein the fluid sample includes a plurality of biological cells;
transferring at least some of the plurality of biological cells of the fluid sample through a microchannel including:
an upstream viscosity-elimination section sized to compress individual ones of the plurality of biological cells, and
a downstream measurement section sized to keep the individual ones of the plurality of biological cells compressed to measure one or more elastic characteristics of the individual ones of the plurality of biological cells;
measuring parameters of the individual ones of the plurality of biological cells at a first detection region of the downstream measurement section and a second detection region of the downstream measurement section; and
determining, based on the measured parameters of the individual ones of the plurality of biological cells at at least one of the first detection region or the second detection region, a health characteristic of the user.

2. The method of claim 1 wherein each of the upstream viscosity-elimination section and the downstream measurement section is sized to compress the individual ones of the plurality of biological cells along their thicknesses.

3. The method of claim 1, wherein at least one of the first detection region or the second detection region is configured to measure stiffness of the individual ones of the plurality of biological cells, wherein at least 90% of the measured stiffness is attributable to an elastic modulus of the individual ones of the plurality of biological cells.

4. The method of claim 1, wherein the first detection region of the microchannel includes a set of electrodes, wherein measuring comprises receiving output signals from the set of electrodes indicative of the individual ones of the plurality of biological cells traveling across the first detection region, and wherein determining comprises determining the health characteristic of the user based only on the output signals received from the set of electrodes at the first detection region.

5. The method of claim 4, wherein determining further comprises, for each of the individual ones of the plurality of biological cells:
analyzing a pulse width of the output signal; and
determining a travel speed of the respective biological cell across the first detection region based on the analyzed pulse width and a distance between the set of electrodes.

6. The method of claim 5, wherein determining further comprises:
plotting a distribution of the determined travel speeds of the individual ones of the plurality of biological cells; and
identifying which of a plurality of distributions, each corresponding to a different value of the health characteristic, matches the plotted distribution.

7. The method of claim 1, wherein measuring comprises measuring (i) a first speed of one of the plurality of biological cells at the first detection region and (ii) a second speed of the one of the plurality of biological cells at the second detection region, and wherein the method further comprises:
calculating a ratio between the first speed and the second speed; and
determining that the calculated ratio is outside of a predetermined range of acceptable ratios,
wherein determining is not based on the first speed or the second speed of the one of the plurality of biological cells.

8. The method of claim 1, wherein measuring comprises, for each of the individual ones of the plurality of biological cells:
measuring a first speed of respective biological cell traveling across the first detection region;
measuring a second speed of the respective biological cell traveling across the second detection region;
calculating a ratio between the second speed and the first speed; and
measuring an amplitude of a phase shift signal pertaining to the respective biological cell at the first detection region or the second detection region.

9. The method of claim 8, wherein determining comprises:
plotting the calculated ratios against the measured amplitudes of the individual ones of the plurality of biological cells to create a measured ratio-versus-amplitude plot; and
identifying which of a plurality of ratio-versus-amplitude plots, each corresponding to a different value of the health characteristic, matches the measured ratio-versus-amplitude plot.

10. The method of claim 9, wherein the plurality of biological cells includes a plurality of red blood cells, wherein the health characteristic includes a glycated hemoglobin level of the user, and wherein, in the plurality of ratio-versus-amplitude plots:
higher glycated hemoglobin levels are correlated with (i) lower ratios between the second speed and the first speed and (ii) lower amplitudes of the phase shift signal,
lower glycated hemoglobin levels are correlated with (i) higher ratios between the second speed and the first speed and (ii) higher amplitudes of the phase shift signal.

11. The method of claim 1, wherein:
measuring comprises, for each of the individual ones of the plurality of biological cells:
measuring a first speed of respective biological cell traveling across the first detection region;
measuring a second speed of the respective biological cell traveling across the second detection region; and
calculating a ratio between the second speed and the first speed, and determining comprises:
determining an initial estimate of the health characteristic of the user based on the calculated ratios of the individual ones of the plurality of biological cells;
determining that the initial estimate is below a predetermined threshold; and
outputting the initial estimate as the determined health characteristic of the user.

12. The method of claim 1, wherein:
measuring comprises, for each of the individual ones of the plurality of biological cells:
measuring a first speed of respective biological cell traveling across the first detection region;
measuring a second speed of the respective biological cell traveling across the second detection region; and
calculating a ratio between the second speed and the first speed, and determining comprises:
determining an initial estimate of the health characteristic of the user based on the calculated ratios of the individual ones of the plurality of biological cells;
determining that the initial estimate is above a predetermined threshold;
discarding the initial estimate;
measuring, for each of the individual ones of the plurality of biological cells, an amplitude of a phase shift signal pertaining to the respective biological cell at the first detection region or the second detection region;
calculating an updated estimate of the health characteristic of the user based on a multivariable analysis considering the calculated ratios and the measured amplitudes of the individual ones of the plurality of biological cells; and
outputting the updated estimate as the determined health characteristic of the user.

13. The method of claim 1, wherein determining comprises determining the health characteristic of the user based on the measured parameters of at least 100 of the plurality of biological cells.

14. A sample-testing cartridge for measuring a health characteristic of a user, the sample-testing cartridge comprising:
a substrate having a plurality of electrodes configured to be operably coupled to an analysis device;
a sensor body carried by the substrate and having a cavity configured to receive a biological fluid sample from a user containing a plurality of biological cells; and
a microchannel layer disposed between the substrate and the sensor body and having a microchannel, wherein the microchannel has (i) an inlet in fluid communication with the cavity, (ii) an outlet, (iii) a first detection region positioned between the inlet and the outlet, and (iv) a second detection region positioned between the first detection region and the outlet,
wherein the first detection region has (i) a first height sized to compress individual ones of the plurality of biological cells along thicknesses of the biological cells and (ii) a first width sized to avoid compressing individual ones of the plurality of biological cells along diameters of the biological cells, and
wherein the second detection region has (i) a second height sized to compress individual ones of the plurality of biological cells along thicknesses of the biological cells and (ii) a second width sized to avoid compressing individual ones of the plurality of biological cells along diameters of the biological cells, wherein the second width is different from the first width.

15. The sample-testing cartridge of claim 14, wherein the second width is greater than the first width.

16. The sample-testing cartridge of claim 14, wherein the second height is substantially equal to the first height.

17. The sample-testing cartridge of claim 14, wherein the microchannel has a constant height between the inlet and the outlet.

18. The sample-testing cartridge of claim 14, wherein the first detection region has a first length, and wherein the second detection region has a second length greater than the first length.

19. The sample-testing cartridge of claim 14, wherein each of the first height of the first detection region and the second height of the second detection region is about 2 μm.

20. The sample-testing cartridge of claim 14, wherein the first width of the first detection region is between 9-13 μm, and wherein the second width of the second detection region is between 26-34 μm.

21. The sample-testing cartridge of claim 14, wherein a length of the first detection region is no more than 140 μm.

22. The sample-testing cartridge of claim 14, wherein each of the substrate and the sensor body is made of glass, and wherein the microchannel layer includes a polyimide patterning layer bonded to the sensor body via surface-level covalent bonding induced by a hot press of the substrate and the sensor body.

23. A method comprising:
transferring a plurality of biological cells of a fluid sample from a user through a microchannel including:
an upstream transient characteristic reduction section configured to alter individual ones of the plurality of biological cells to reduce a transient characteristic of the individual ones of the plurality of biological cells, which would significantly affect measurement of a parameter of the cells, and
a downstream measurement section configured to measure one or more steady state characteristics of the individual ones of the plurality of biological cells while maintaining the reduction of the transient characteristic of the individual ones of the plurality of biological cells; and
measuring the one or more steady state characteristics of the individual ones of the plurality of biological cells at a measurement section an of downstream measurement section.

24. The method of claim 23, further comprising determining, based on the measuring of the one or more steady state characteristics, a health characteristic of the user.

25. The method of claim 23, further comprising using a first detection region and a second detection region of the downstream measurement section to measure the one or more steady state characteristics.

26. The method of claim 23, wherein the downstream measurement section include one or more energy emitting sensor assembles for measuring the one or more steady state characteristics based on energy passing through the individual ones of the plurality of biological cells.
